(19) United States
(12) Patent Application Publication
(10) Pub. No.: US 2010/0026236 A1
(43) Pub. Date: Feb. 4, 2010

(54) POWER TRANSMISSION CONTROL DEVICE, POWER TRANSMISSION DEVICE, POWER RECEIVING CONTROL DEVICE, POWER RECEIVING DEVICE, ELECTRONIC APPARATUS, AND CONTACTLESS POWER TRANSMISSION METHOD

(75) Inventors: Masayuki KAMIYAMA, Nagoya-shi (JP); Kota ONISHI, Nagoya-shi (JP); Nobutaka SHIOZAKI, Nagoya-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/503,461

(22) Filed: Jul. 15, 2009

(30) Foreign Application Priority Data
Jul. 16, 2008 (JP) 2008-185398
Jul. 1, 2009 (JP) 2009-156815

(51) Int. Cl. H02J 17/00; H02J 7/00

(52) U.S. Cl. 320/108; 307/104

(57) ABSTRACT

A power transmission control device provided to a power transmission device of a contactless power transmission system includes a controller including an authentication process section and a command process section. The authentication process section performs an authentication process on a power receiving device before normal power transmission from the power transmission device to the power receiving device starts. If an event proceeding to a communication mode in which the power transmission device and the power receiving device communicate with occurs, after the normal power transmission starts, the command process section proceeds to a command branch phase without proceeding to a phase of the authentication process, and performs a command process on the communication mode in the command branch phase.

This application is based upon and claims benefit of priority from prior Japanese Patent Application No. 2008-185398, filled Jul. 16, 2008, and Japanese Patent Application No. 2009-156815, filled Jul. 1, 2009, the entire contents of which are incorporated herein by reference.

### BACKGROUND OF THE INVENTION

1. Field of the Invention

The present invention relates to a power transmission control device, a power transmission device, a power receiving control device, a power receiving device, an electronic apparatus, and a contactless power transmission method.

2. Related Art

In recent years, contactless power transmission (non-contact power transmission) has been highlighted. The contactless power transmission makes it possible to perform transmission of electric power by utilizing electromagnetic induction without using a metallic contact. As an example of the contactless power transmission, charging cell-phones and household equipment (e.g., cordless handsets of telephones) are suggested.

Japanese Unexamined Patent Application Publication No. 2006-60909 is an example of related art of the contactless power transmission. In the example, an ID authentication is realized by transmitting and receiving an authentication code between a power transmission side (a primary side) and a power receiving side (a secondary side) so as to detect insertion of a foreign object or the like.

In the related art disclosed in the Japanese Unexamined Patent Application Publication No. 2006-60909, however, while the authentication code is communicated between the power transmission side and the power receiving side, it is not assumed to take measures on replacement on the power receiving side after the detection of the full charge as well as to confirm a secondary side received power level that depends on the positional relation between the power transmission side and the power receiving side. The taking measures and the confirmation are better to be performed each in the communication mode between the power transmission side and the power receiving side, and before charging starts.

### SUMMARY OF THE INVENTION

According to some aspects of the invention, a power transmission control device, a power transmission device, a power receiving control device, a power receiving device, an electronic apparatus, a contactless power transmission method, and the like that can realize an appropriate communication mode can be provided.

### PROBLEMS TO BE SOLVED

An aspect of the invention is a power transmission control device provided in a power transmission device of a contactless power transmission system. The power transmission control device includes a controller controlling the power transmission control device. The controller includes an authentication process section and a command process section. The authentication process section performs an authentication process on a power receiving device before normal power transmission from the power transmission device to a power receiving device starts. If an event proceeding to a communication mode in which the power transmission device and the power receiving device communicate with occurs, after the normal power transmission starts, the command process section proceeds to a command branch phase without proceeding to a phase of the authentication process, and performs a command process on the communication mode in the command branch phase.

According to the aspect, the authentication process is performed before the start of the normal power transmission to the power receiving device. If the event proceeding to the communication mode occurs after the start of the normal power transmission, the command process section proceeds to the command phase so as to perform the command process on the communication mode without proceeding to the authentication process phase. Consequently, an appropriate communication mode can be realized.

In the aspect of the invention, the controller may include a power transmission control section that stops the normal power transmission if a removal of an electronic apparatus on a power receiving side is detected, if a foreign object is detected, or if a full charge of a battery included in a load of the power receiving device is detected. The authentication process section may perform the authentication process in a temporary power transmission period after the normal power transmission stops, and proceed to the command branch phase after the authentication process phase in the temporary power transmission period.

According to the aspect, if the removal or the full charge is detected, the normal power transmission stops, and in the temporary power transmission period after the stop of the normal power transmission, the authentication process is performed. Then, the authentication process section proceeds to the command branch phase. Consequently, replacement on the power receiving side or the like can be detected by the authentication process.

The aspect of the invention also may include a host interface to communicate with a power transmission side host. The command process section may proceed to the command branch phase so as to perform the command process on the communication mode if the power transmission side host issues a communication request command to a power receiving side host through the host interface.

According to the aspect, the command process section proceeds to the communication mode by the communication request command issued by the power transmission side host, and can perform the command process on the communication mode.

In the aspect of the invention, the command process section may proceed to the command branch phase so as to perform the command process on the communication mode if the command process section receives a communication interrupt command issued by the power receiving side host.

According to the aspect, the command process section proceeds to the communication mode by the interrupt request command issued by the power receiving side host, and can perform the command process on the communication mode.

In the aspect of the invention, the command process section may return to the command branch phase after the command process on the communication mode ends.

According to the aspect, the command process section returns to the command branch phase after the completion of the command process on the communication mode, and can perform a process on another command. At this time, if there is position shift when the recharge starts after the communication or the full charge, the restart of power transmission is halted by adding received power level information, which depends on the positional relation between the primary and secondary coils, to the charging reply command from the power receiving side (secondary side), for example. As a result, unwanted troubles due to transmission failures can be avoided before they happen.

In the aspect of the invention, the command process section may set at least one of a transmission condition and a communication condition of the contactless power transmission to a condition for the communication mode, the condition being different from a condition for the normal power transmission, if the command process section proceeds to the communication mode.

According to the aspect, the transmission and communication conditions for the communication mode can be set separately from the transmission and communication conditions for the normal power transmission. As a result, the reliability of communications can be improved.

In the aspect of the invention, if a full charge of a battery included in the load is detected and the normal power transmission stops, the controller may proceed to a waiting phase after the detection of the full charge, and include a recharge confirmation process section that periodically performs a recharge confirmation process on the battery in the waiting phase after the detection of the full charge.

According to the aspect, the power transmission stops after the detection of the full charge, and the controller can periodically perform the recharge confirmation process on the battery. As a result, power can be saved.

In the aspect of the invention, the authentication process section may perform the authentication process in a period in which a temporary power transmission is periodically performed in the waiting phase after the detection of the full charge, and proceed to the command branch phase after the authentication process in the temporary power transmission period.

According to the aspect, the power receiving side is powered on by the temporary power transmission for the recharge confirmation, and can perform the recharge confirmation process.

In the aspect of the invention, the recharge confirmation process section may set a recharge confirmation flag to a set state at a time at which the waiting phase after the detection of the full charge proceeds to the authentication process phase.

Setting the recharge confirmation flag to the set state as described above allows proceeding to the recharge confirmation process at the command branch phase after the authentication process by using the recharge confirmation flag.

In the aspect of the invention, the recharge confirmation process section may set the recharge confirmation flag to a reset state if it is determined that the battery needs to be recharged in the recharge confirmation process and the normal power transmission starts.

Setting the recharge confirmation flag to the reset state as described above allows proceeding to the normal power transmission mode or the like at the command branch phase.

In the aspect of the invention, the recharge confirmation process section may transmit a recharge confirmation command to the power receiving device in the recharge confirmation process, and determine whether or not the battery needs to be recharged, when receiving a reply command notifying a charging state of the battery from the power receiving device, based on the reply command.

This makes it possible to confirm the charging state of the battery by using the reply command from the power receiving device.

Another aspect of the invention is a power transmission device including the power transmission control device according to any of ones described above, and a power transmission section generating an alternating voltage so as to supply the voltage to a primary coil.

Another aspect of the invention is an electronic apparatus including the power transmission device described above.

Further another aspect of the invention is a power receiving control device provided in a power transmission device of a contactless power transmission system. The power receiving control device includes a controller controlling the power receiving control device. The controller includes an authentication process section and a command process section. The authentication process section performs an authentication process on a power transmission device before normal power transmission from the power transmission device to the power receiving device starts. If an event proceeding to a communication mode in which the power transmission device and the power receiving device communicate with occurs, after the normal power transmission starts, the command process section proceeds to a command branch phase without proceeding to a phase of the authentication process, and performs a command process on the communication mode in the command branch phase.

According to the further another aspect of the invention, the authentication process is performed before the start of the normal power transmission from the power transmission device. If the event proceeding to the communication mode occurs after the start of the normal power transmission, the command process section proceeds to the command phase so as to perform the command process on the communication mode without proceeding to the authentication process phase. Consequently, an appropriate communication mode can be realized.

The further another aspect of the invention also may include a host interface to communicate with a power receiving side host. The command process section may proceed to the command branch phase so as to perform the command process on the communication mode if the power receiving side host issues a communication request command to a power transmission side host through the host interface.

According to the further another aspect, the command process section proceeds to the communication mode by the communication request command issued by the power receiving side host, and can perform the command process on the communication mode.

In the further another aspect of the invention, the command process section may proceed to the command branch phase so as to perform the command process on the communication mode if the command process section receives an interrupt command to request communication, the command being issued by the power transmission side host.

According to the further another aspect, the command process section proceeds to the communication mode by the interrupt request command issued by the power transmission side host, and can perform the command process on the communication mode.

In the further another aspect of the invention, the controller may include a recharge confirmation process section. If a full charge of a battery included in a load of the power receiving device is detected and the normal power transmission stops, the power transmission device may proceed to a waiting phase after the detection of the full charge. The recharge confirmation process section may transmit a replay command notifying a charging state of the battery to the power transmission device if the recharge confirmation process section receives a recharge confirmation command from the power transmission device in the waiting phase after the detection of the full charge.

Transmitting the reply command notifying the charging state of the battery with respect to the recharge confirmation command received from the power transmission device allows notifying the charging state of the battery to the power transmission side.

In the further another aspect of the invention, if the power transmission device periodically performs a temporary power transmission for a recharge confirmation in the waiting phase after the detection of the full charge, the recharge confirmation process section may receive the recharge confirmation command and transmit the reply command in a period of the temporary power transmission for the recharge confirmation.

According to the further another aspect, the recharge confirmation process section is powered on by the temporary power transmission for the recharge confirmation, and can perform the command process, such as receiving the recharge confirmation command and transmitting the reply command.

Still another aspect of the invention is a power receiving device including the power receiving control device according to any of ones described above, and a power receiving section converting an induced voltage in a secondary coil into a direct current voltage.

Still another aspect of the invention is an electronic apparatus including the power receiving device described above, and a load to which power is supplied by the power receiving device.

Further still another aspect of the invention is a contactless power transmission method in which power is transmitted from a power transmission device to a power receiving device by electromagnetically coupling an elementary coil and a secondary coil and the power is supplied to a load of the power receiving device. The method includes: performing an authentication process on the power receiving device before normal power transmission from the power transmission device to the power receiving device starts; proceeding to a command branch phase without proceeding to a phase of the authentication process if an event proceeding to a communication mode in which the power transmission device and the power receiving device communicate with occurs, after the normal power transmission starts; and performing a command process on the communication mode in the command branch phase.

In the further still another aspect of the invention, the normal power transmission may be stopped if a removal of an electronic apparatus on a power receiving side is detected, if a foreign object is detected, or if a full charge of a battery included in a load of the power receiving device is detected; a temporary power transmission may be performed after the normal power transmission stops; the authentication process may be performed in a period of the temporary power transmission; and the step may proceed to the command branch phase after the authentication process phase in the temporary power transmission period.

In the further still another aspect of the invention, at least one of a transmission condition and a communication condition of the contactless power transmission may be set to a condition for the communication mode, the condition being different from a condition for the normal power transmission, if the step proceeds to the communication mode.

In the further still another aspect of the invention, the step may proceed to a waiting phase after detection of a full charge, if the full charge of a battery included in the load is detected and the normal power transmission stops; and a recharge confirmation process on the battery may be periodically performed in a waiting phase after the detection of the full charge.

In the further still another aspect of the invention, it may be determined whether or not the battery needs to be recharged, if a charging state of the battery is received from the power receiving device in the recharge confirmation process on the battery, based on the charging state.

### BRIEF DESCRIPTION OF THE DRAWINGS

FIGS. 1(A), 1(B), and 1(C) are explanatory views of contactless power transmission.

FIG. 2 is a structural example of a power transmission device, a power transmission control device, a power receiving device, and a power receiving control device according to an embodiment.

FIGS. 3(A) and 3(B) are explanatory views of data transmission by a frequency modulation and a load modulation.

FIG. 4 is a flowchart briefly explaining the operation according to the embodiment.

FIGS. 5(A) to 5(C) are explanatory views of the operation according to the embodiment.

FIGS. 6(A) to 6(C) are explanatory views of the operation according to the embodiment.

FIGS. 7(A) to 7(C) are explanatory views of the operation according to the embodiment.

FIGS. 8(A) to 8(C) are explanatory views of the operation according to the embodiment.

FIGS. 9(A) to 9(C) are explanatory views of the operation according to the embodiment.

FIG. 10 is an explanatory view of a process sequence of the contactless power transmission.

FIG. 11 is an explanatory view of a process sequence of the contactless power transmission.

FIG. 12 is a specific structural example of the power transmission device, the power transmission control device, the power receiving device, and the power receiving control device according to the embodiment.

FIG. 13 is a flowchart explaining the operation according to the embodiment.

FIG. 14 is a flowchart explaining the operation according to the embodiment.

FIG. 15 is a flowchart explaining the operation according to the embodiment.

### DESCRIPTION OF PREFERRED EMBODIMENTS

Embodiments of the invention will be described in detail below. The embodiments explained below do not unduly limit the contents of the invention described in the claims and all of the structures explained in the embodiments are not indispensable for the solving means of the invention.

### 1. Electronic Apparatus

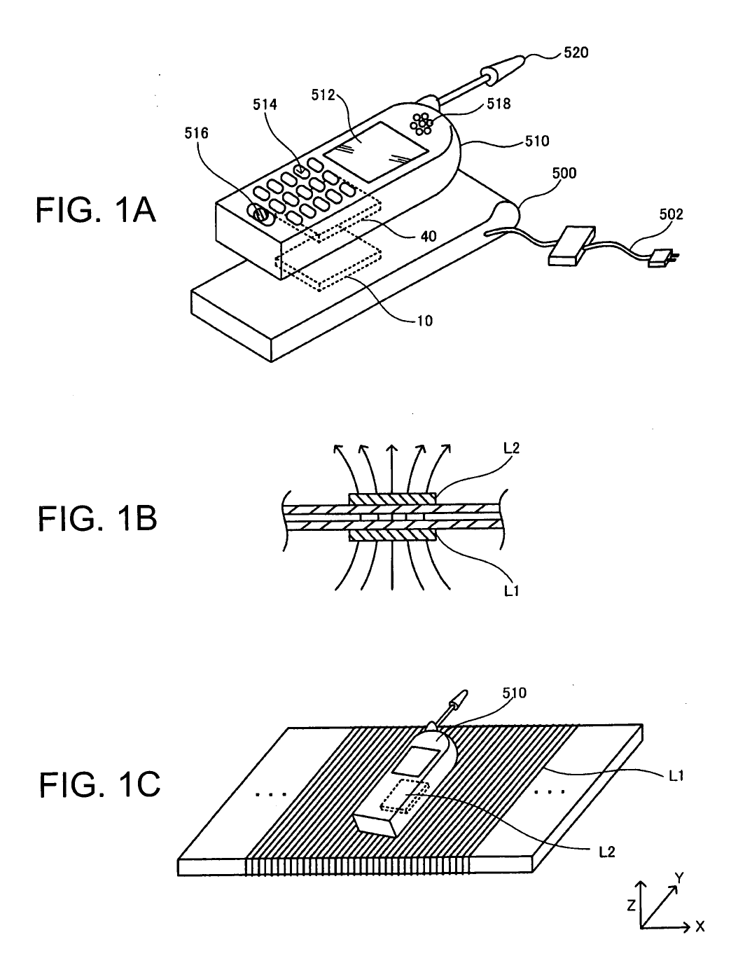

FIG. 1(A) shows an example of an electronic apparatus employing a contactless power transmission method according to the embodiment of the invention. A charger 500 (a cradle) that is one of electronic apparatuses includes a power transmission device 10. A cell-phone 510 that is one of electronic apparatuses includes a power receiving device 40. The cell-phone 510 includes a display 512 such as LCD, an operation section 514 composed of buttons and the like, a microphone 516 (a sound input section), a speaker 518 (a sound output section), and an antenna 520.

Power is supplied to the charger 500 through an AC adapter 502, and then the power is transmitted from the power transmission device 10 to the power receiving device 40 by contactless power transmission. Accordingly, a battery of the cell-phone 510 can be charged and devices in the cell-phone 510 can be operated.

The electronic apparatus, to which the embodiment is applied, is not limited to the cell-phone 510. The embodiment is applicable to various electronic apparatuses such as watches, cordless phones, shavers, electric toothbrushes, wrist computers, handy terminals, personal digital assistants, electric bicycles, and IC cards.

As schematically shown in FIG. 1(B), power transmission from the power transmission device 10 to the power receiving device 40 is realized by electromagnetically coupling a primary coil L1 (a power transmission coil) provided on a power transmission device 10 side and a secondary coil L2 (a power receiving coil) provided on a power receiving device 40 side and thus forming a power transmission transformer. This enables non-contact power transmission to be performed.

In FIG. 1(B), the primary coil L1 and the secondary coil L2 are, for example, flat coils having an air-core formed by winding a coil wire in a spiral manner on a plane. However, the coils of the embodiment are not limited to these. Any coils can be used regardless of their shapes, structures, and the like as long as ones can be used to transmit power by electromagnetically coupling the primary coil L1 and the secondary coil L2

For example, referring to FIG. 1(C), the primary coil L1 is formed by winding a coil wire around a magnetic substance core in a spiral manner about an X axis. The secondary coil L2 provided to the cell-phone 510 is similarly formed. The embodiment is also applicable to the coil shown in FIG. 1(C). In a case shown in FIG. 1(C), a combination of the coils obtained by winding a coil wire about the X axis and a coil obtained by winding a coil wire about a Y axis may be used as the primary coil L1 or the secondary coil L2.

### 2. Structure

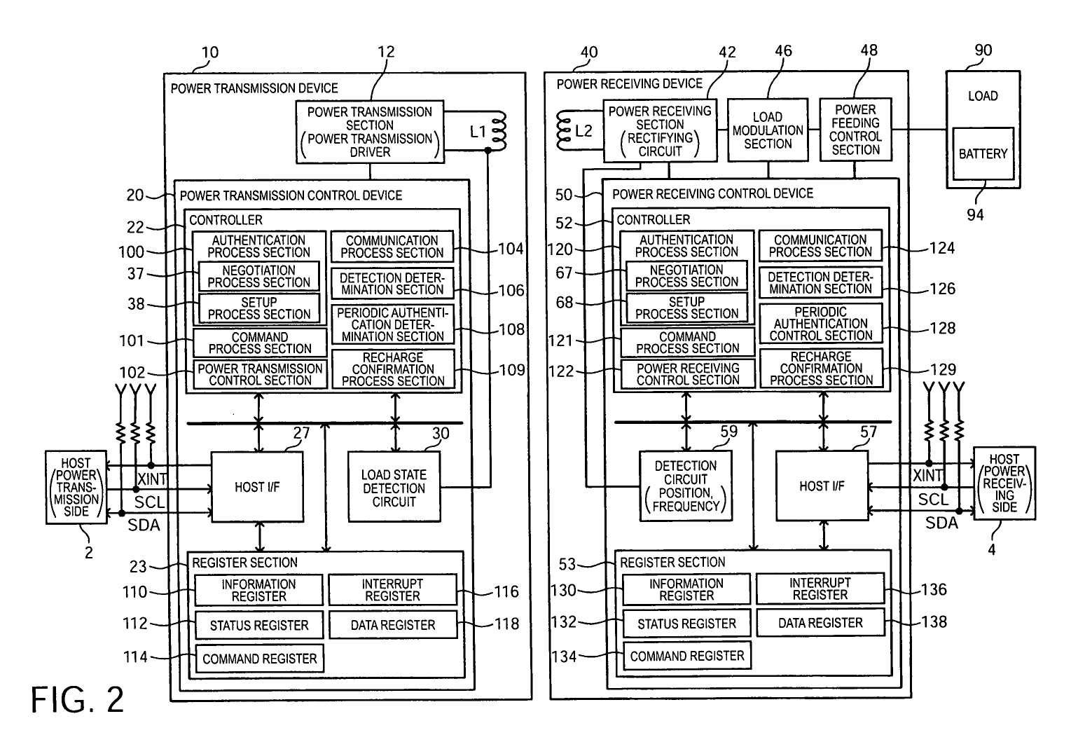

FIG. 2 shows a structural example of the power transmission device 10, a power transmission control device 20, the power receiving device 40, and a power receiving control device 50 according to the embodiment. The electronic apparatus, such as the charger 500 shown in FIG. 1(A), on a power transmission side, includes the power transmission device 10 and a host 2, on the power transmission side, shown in FIG. 2. The electronic apparatus, such as the cell-phone 510, used on a power receiving side may include the power receiving device 40, a load 90 (main load), and a host 4 used on the power receiving side. The hosts (host processors) 2 and 4 can be realized by, for example, a CPU, an application processor, an ASIC circuit, or the like, and perform various controls such as an overall control process of the electronic apparatuses on the power transmission side and the power receiving side. Based on a structure shown in FIG. 2, a contactless power transmission (non-contact power transmission) system is realized in which the primary coil L1 and the secondary coil L2 are electromagnetically coupled so as to transmit power from the power transmission device 10 to the power receiving device 40 to supply the power to the load 90, for example.

The power transmission device 10 (a power transmission module, a primary module) may include the primary coil L1, a power transmission section 12, and the power transmission control device 20. The structures of the power transmission device 10 and the power transmission control device 20 are not limited to those shown in FIG. 2, and various modifications, such as omitting a part of components, adding another component (e.g., a waveform monitor circuit), and changing connections, can be made. For example, the power transmission section 12 may be included in the power transmission control device 20.

The primary coil L1 (a coil used on the power transmission side) and the secondary coil L2 (a coil used on the power receiving side) are electromagnetically coupled to each other so as to form a power transmission transformer. For example, when power transmission is required, as shown in FIGS. 1(A) and 1(B), the cell-phone 510 is placed on the charger 500 so that magnetic flux of the primary coil L1 passes through the secondary coil L2. On the other hand, when the power transmission is not required, the cell-phone 510 is physically separated from the charger 500 so that magnetic flux of the primary coil L1 does not pass through the secondary coil L2.

The power transmission section 12 generates an alternating current voltage having a predetermined frequency during power transmission, and generates an alternating current voltage having a frequency, which varies in accordance with data, during data transfer so as to supply the voltage to the primary coil L1. The power transmission section 12 may include a first power transmission driver for driving one end of the primary coil L1, a second power transmission driver for driving the other end of the primary coil L1, and at least one capacitor forming a resonance circuit together with the primary coil L1. Each of the first and the second power transmission drivers included in the power transmission section 12 is an inverter circuit (a buffer circuit) composed of, for example, power MOS transistors, and is controlled by the power transmission control device 20.

In FIG. 2, data communication from the power transmission side to the power receiving side is realized by a frequency modulation while data communication from the power receiving side to the power transmission side is realized by a load modulation.

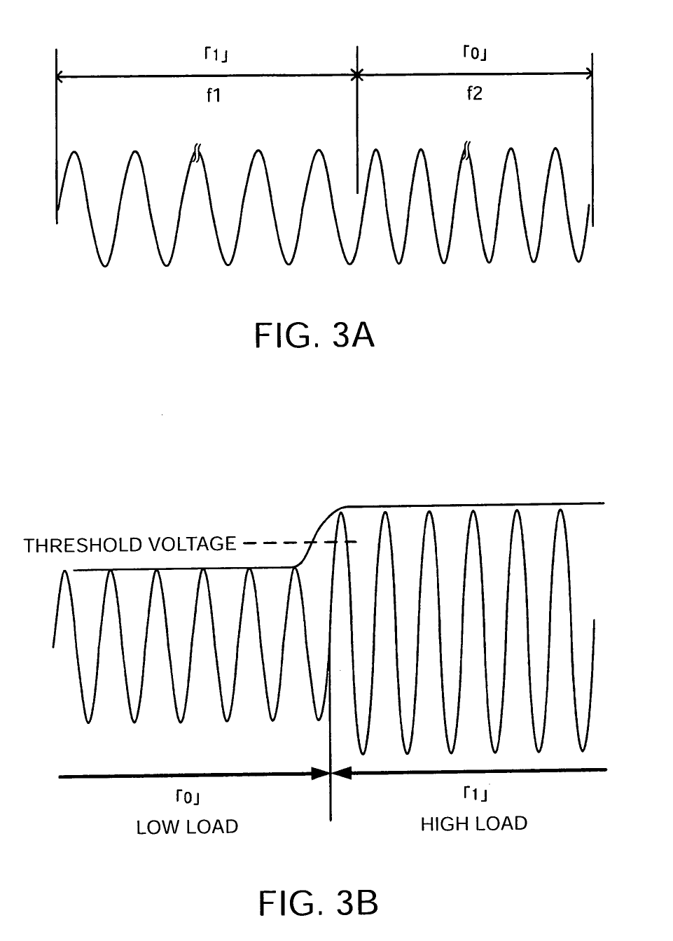

Specifically, as shown in FIG. 3(A), for example, when data “1” is transmitted to the power receiving side, the power transmission section 12 generates an alternating current voltage of a frequency f1. When data “0” is transmitted, the power transmission section 12 generates an alternating current voltage of a frequency f2. Then, a detection circuit 59, on the power receiving side, detects the frequency change so as to determine data “1” or “0.” As a result, data communication by the frequency modulation from the power transmission side to the power receiving side can be realized.

On the other hand, a load modulation section 46, on the power receiving side, variably changes a load of the power receiving side in accordance with data to be transmitted. As shown in FIG. 3(B), a signal waveform of an induced voltage of the primary coil L1 is varied. For example, when data “1” is transmitted to the power transmission side, the power receiving side is in a high load state. When data “0” is transmitted, the power receiving side is in a low load state. Then, a load state detection circuit 30, on the power transmission side, detects the load state change on the power receiving side so as to determine data “1” or “0.” As a result, data communication by the load modulation from the power receiving side to the power transmission side can be realized.

In FIGS. 3(A) and 3(B), data communication from the power transmission side to the power receiving side is realized by the frequency modulation while data communication from the power receiving side to the power transmission side is realized by the load modulation. However, another modulation method or other methods may be employed.

The power transmission control device 20 performs various controls of the power transmission device 10, and can be realized by an integrated circuit (IC) device, a micro computer with a program, or the like. The power transmission control device 20 may include a controller 22, a register section 23, a host I/F (interface) 27, and the load state detection circuit 30. In this regard, modifications, such as omitting a part of the components (e.g., the host I/F, the load state detection circuit) or adding another component, can be made.

The controller 22 (on the power transmission side) controls the power transmission control device 20 and the power transmission device 10. The controller 22 can be realized by an ASIC circuit such as a gate array, a micro computer with a program operating on the micro computer, or the like. The controller 22 controls power transmission using the power transmission section 12, the register section 23 and the load state detection circuit 30.

The controller 22 includes an authentication process section 100, a command process section 101, a power transmission control section 102, a communication process section 104, a detection determination section 106, a periodic authentication determination section 108, and a recharge confirmation process section 109.

The authentication process section 100 performs an authentication process. For example, a collation process is performed in which power receiving side authentication information (e.g., standard/coil/system information on the power receiving side) is collated with power transmission side authentication information (e.g., standard/coil/system information on the power transmission side) by a negotiation process and the like, which is described later, so as to authenticate whether or not the power receiving device 40 is an appropriate device. The command process section 101 handles the commands issued by the power transmission side and the power receiving side. The power transmission control section 102 performs a power transmission control. The power transmission control section 102 performs, for example, a sequence control and a power control on power transmission (normal power transmission, temporary power transmission) of contactless power transmission. The communication process section 104 performs a communication process between the power transmission device 10 and the power receiving device 40. For example, the communication process section 104 controls a data transmission process in which data is transmitted to the power receiving side by the frequency modulation or the like and a data receiving process receiving data from the power receiving side by the load demodulation and the like. The detection determination section 106 determines detection such as foreign object detection and removal detection, when the load state detection circuit 30 detects a load state on the power receiving side, based on the detected information, for example. The periodic authentication determination section 108 performs a determination process that determines whether or not appropriate periodic authentication is performed, when the power receiving side performs periodic authentication after the start of normal power transmission, for example. The recharge confirmation process section 109 performs a recharge confirmation process after the detection of full charge.

The register section 23 (a storing section) can be accessed (written, read) by the host 2, on the power transmission side, through the host I/F 27, and can be realized by RAMs, D flip-flops, or the like, for example. The register section 23 includes an information register 110, a status register 112, a command register 114, an interrupt register 116, and a data register 118. Information to be stored in the register section 23 may be stored in nonvolatile memories such as flash memories and mask ROMs.

The information register 110 stores information such as a transmission condition and a communication condition of contactless power transmission. The information register 110 stores, for example, parameters of the driving frequency and the driving voltage as well as parameters (threshold values) to detect the load state on the power receiving side. The status register 112 is used to confirm various states, such as a power transmission state and a communication state, by the host 2. The command register 114 is used to write various commands by the host 2. The interrupt register 116 is used for various interrupts, and includes a register to set enable/disable of the various interrupts and a register to notify the host 2 of a factor of the interrupt, for example. The data register 118 is used to buffer data transmitted to a charge side and data received from the power receiving side.

The host I/F 27 is an interface to communicate with the host 2, on the power transmission side, and the communication can be realized by I2C (Inter Integrated Circuit) in FIG. 2. The host 2 is a CPU or the like included in the electronic apparatus (a charger) on the power transmission side.

The I2C is a communication method to exchange data between a plurality of devices provided closely on a same substrate and the like. The communication is performed by sharing two signal lines—an SDA (serial data) and an SCL (serial clock)—as a bus between the plurality of the devices. Specifically, the communication is realized by connecting the plurality of the devices serving as slaves to one of the devices serving as a master (a host) with the bus. The slave side can interrupt the master using a XINT (external Interrupt). The slave side can also request an interrupt from the I2C bus. The communication method between the host and the host I/F is not limited to the I2C, and communication methods based on similar ideas to the I2C, and typical communication methods such as a serial interface and a parallel interface may be employed.

The load state detection circuit 30 (a waveform detection circuit) detects a load state on the power receiving side (the power receiving device or foreign objects). The load state detection can be realized by detecting variations in the waveform of an induced voltage signal (a coil terminal signal) of the primary coil L1. For example, a variation of a load state (a load current) on the power receiving side (the secondary side) induces a variation in the waveform of the induced voltage signal. The load state detection circuit 30 detects the variation in the waveform, and outputs a detection result (detection result information) to the controller 22. Then, the controller 22, based on the detection information on the load state of the load state detection circuit 30, determines the load state (load fluctuation, a degree of the load) of the power receiving side (the secondary side).

The power receiving device 40 (a power receiving module, a secondary module) may include the secondary coil L2, the power receiving section 42, the load modulation section 46, a power feeding control section 48, and the power receiving control device 50. The structures of the power receiving device 40 and the power receiving control device 50 are not limited to those shown in FIG. 2, and various modifications, such as omitting a part of components (e.g., the load modulation section), adding another component, and changing connections, can be made. For example, any of the power receiving section 42, the load modulation section 46, and the power feeding control section 48 may be included in the power receiving control device 50.

The power receiving section 42 converts an alternating induced voltage of the secondary coil L2 into a direct-current voltage. This conversion can be realized by a rectifying circuit included in the power receiving section 42, and the like.

The load modulation section 46 performs a load modulation process. Specifically, when data is transmitted from the power receiving side to the power transmission side, a load on the load modulation section 46 (the secondary side) is variably changed in accordance with data to be transmitted so as to vary a signal waveform of the induced voltage of the primary coil L1 as shown in FIG. 3(B).

The power feeding control section 48 controls a power feeding to the load 90. That is, the power feeding control section 48 controls turning on or off the power feeding to the load 90. Specifically, a level of the direct-current voltage from the power receiving section 42 (the rectifying circuit) is regulated so as to generate a power supply voltage. Thereafter, the power supply voltage is supplied to the load 90 so as to charge a battery 94 of the load 90. The load 90 may not include the battery 94.

The power receiving control device 50 performs various controls of the power receiving device 40, and can be realized by an integrated circuit (IC) device, a micro computer with a program, or the like. The power receiving control device 50 can be operated with a power supply voltage generated from the induced voltage of the secondary coil L2. The power receiving control device 50 may include a controller 52, a register section 53, a host I/F 57, and a detection circuit 59. In this regard, modifications, such as omitting a part of the components (e.g., the host I/F, the detection circuit) and adding another component, can be made.

The controller 52 (on the power receiving side) controls the power receiving control device 50 and the power receiving device 40. The controller 52 can be realized by an ASIC circuit such as a gate array, a micro computer with a program operating on the micro computer, or the like. The controller 52 controls the load modulation section 46, the power feeding control section 48, and the register section 53.

The controller 52 includes an authentication process section 120, a command process section 121, a power receiving control section 122, a communication process section 124, a detection determination section 126, a periodic authentication control section 128, and a recharge confirmation process section 129.

The authentication process section 120 performs an authentication process. For example, a collation process is performed in which power receiving side authentication information is collated with power transmission side authentication information by the negotiation process and the like so as to authenticate whether or not the power transmission device 10 is an appropriate device. The command process section 121 handles the commands issued by the power receiving side and the power transmission side. The power receiving control section 122 performs a power receiving control. The power receiving control section 122 performs, for example, a sequence control for power receiving of contactless power transmission. The communication process section 124 controls, for example, a data transmission process in which data is transmitted to the power transmission side by the load modulation and a data receiving process receiving data from the power transmission side by the frequency modulation. The detection determination section 126, when the detection circuit 59 detects a position or a frequency, performs detection determination based on the detection information. The periodic authentication control section 128 controls periodic authentication performed after the start of normal power transmission. For example, in order to detect a so-called takeover state by a foreign object, the periodic authentication section 128 periodically (intermittently) varies a load state of the power receiving side after the start of normal power transmission. The recharge confirmation process section 129 performs a recharge confirmation process after the detection of full charge.

The register section 53 (a storing section) can be accessed by the host 4 on the power receiving side through the host I/F 57, and can be realized by RAMs, D flip-flops, or the like, for example. The register section 53 includes an information register 130, a status register 132, a command register 134, an interrupt register 136, and a data register 138. Information to be stored in the register section 53 may be stored in nonvolatile memories such as flash memories and mask ROMs.

Since the functions of the information register 130, the status register 132, the command register 134, the interrupt register 136, and the data register 138 are almost the same as the registers on the power transmission side, the description thereof is omitted.

The host I/F57 is an interface to communicate with the host 4 on the power receiving side, for example, by the I2C or the like. The host 4 is a CPU or an application processor included in the electronic apparatus on the power receiving side. The detection circuit 59 detects a positional relation between the primary coil L1 and the secondary coil L2 as well as a coil driving frequency during the data transmission from the power transmission side to the power receiving side.

The authentication process section 100 on the power transmission side includes a negotiation process section 37 and a setup process section 38, and the authentication process section 120 on the power receiving side may also include a negotiation process section 67 and a setup process section 68.

The negotiation process sections 37 and 67 perform a negotiation process of contactless power transmission. That is, between the power transmission side and the power receiving side, information on basic settings of contactless power transmission (a standard, a coil, a system, a safety feature, and the like) is exchanged. The setup process sections 38 and 68, based on a result of the negotiation process, perform a setup process of contactless power transmission. That is, after the authentication process basic of contactless power transmission is made in the negotiation process, setup information different from each apparatus and application is exchanged between the power transmission side and the power receiving side. The command process sections 101 and 121 perform a command process of contactless power transmission after the setup process. That is, basic commands and commands that become available in the setup process are issued and executed.

Specifically, the negotiation process section 37, on the power transmission side, performs a confirmation process that confirms whether or not information can be communicated with the power receiving device 40, a confirmation process that confirms whether or not the communicated information is adequate, and a confirmation process that confirms whether or not a load state on the power receiving device is appropriate. More specifically, the negotiation process section 37 performs a collation process that collates standard information, coil information, and system information with the information of the power receiving device 40. The system information indicates a load state detection method.

The setup process section 38, based on a result of the negotiation process, sets a transmission condition of contactless power transmission. Specifically, when the power receiving device 40 transmits transmission condition information of contactless power transmission, the setup process section 38 receives the transmission condition information so as to set the transmission condition of the contactless power transmission. That is, when the power receiving device 40 transmits transmission condition information, such as a driving voltage as well as a driving frequency of a coil, required for normal power transmission, the setup process section 38 sets a transmission condition such as the driving voltage and the driving frequency based on the transmission condition information. When the power receiving device 40 transmits communication condition information, the setup process section 38 receives the communication condition information so as to set a communication condition. That is, when the power receiving device 40 transmits communication condition information that designates a communication method, a communication parameter, and the like, the setup process section 38 sets a communication condition based on the communication condition information. The setup process section 38 exchanges setup information different from each apparatus and application with the power transmission device 10.

After the setup process, the command process section 101 processes various commands such as a normal power transmission start command, a detection command on a full charge of the battery 94 (a full charge notifying command), and a confirmation command on a recharge of the battery 94. That is, the command process section 101 issues and executes these commands.

The negotiation process section 67, on the power receiving side, performs a confirmation process that confirms whether or not information can be communicated with the power transmission device 10, and a confirmation process that confirms whether or not the communicated information is adequate. That is, the negotiation process section 67 transmits standard/coil/system information to the power transmission side, and receives standard/coil/system information from the power transmission side so as to confirm whether or not the standard/coil/system information on the power transmission side and the standard/coil/system information on the power receiving side are compatible (matched).

The setup process section 68, based on a result of the negotiation process, transmits transmission condition information of contactless power transmission and communication condition information to the power transmission device 10. That is, transmission condition information, such as the driving voltage and the driving frequency of the coil, required for normal power transmission is transmitted. In addition, communication condition information, such as the communication method and the communication parameter, is transmitted. Further, different setup information for each apparatus and application is exchanged with the power transmission device 10.

After the setup process, the command process section 121 performs various command processes such as the normal power transmission start command, the detection command on a full charge of the battery 94, the confirmation command on a recharge of the battery 94, and a communication command. That is, the command process section 121 issues and executes these commands.

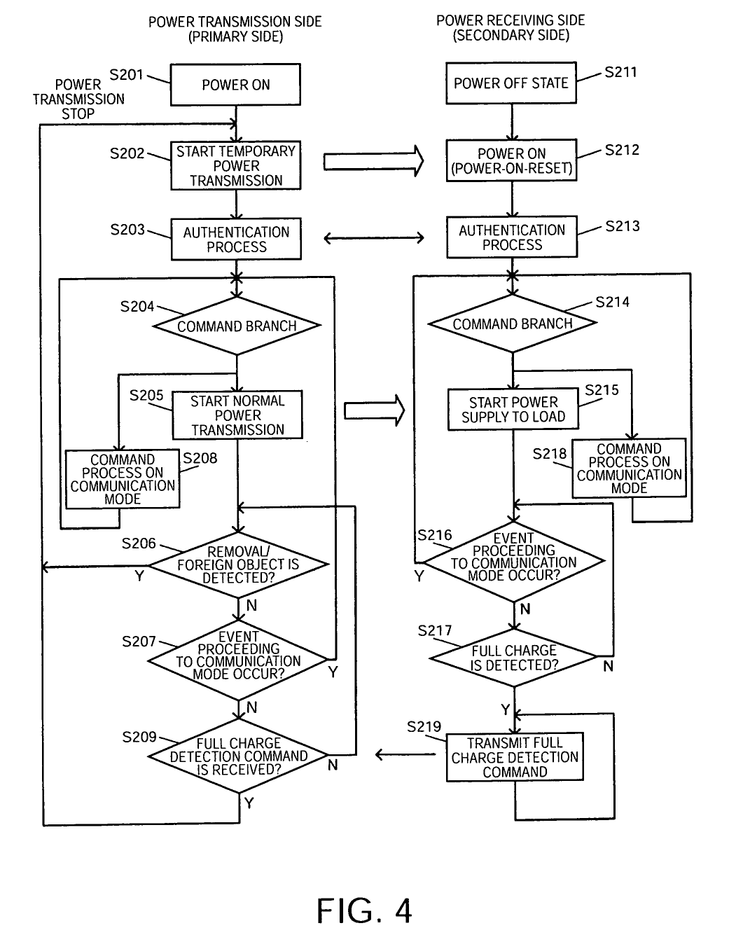

FIG. 4 shows a flow chart to explain the outline of the operation according to the embodiment.

The power transmission side starts a temporary power transmission after a power-on (steps S201, S202). The power receiving side, thus, is powered on and reset (steps S211, S212). Then, the power transmission side and the power receiving side perform the authentication process by exchanging authentication information and the like (steps S203, S213).

After the authentication process, the power transmission side and the power receiving side proceed to a command branch phase (a period or a mode in which branched commands are executed) (steps S204, S214). Once the power transmission side starts normal power transmission, the power receiving side starts to supply power to the load (steps S205, S215).

After starting the normal power transmission, the power transmission side performs removal detection of an electronic apparatus on the power receiving side or foreign object detection (step S206). If a removal or a foreign object is detected, the power transmission side stops the power transmission to the power receiving side. Then, the power transmission side performs a temporary power transmission, and proceeds to an authentication process phase (a period or a mode in which the authentication process is performed) (steps S202, S203).

If the removal or the foreign object is not detected, the power transmission side determines whether or not an event proceeding to a communication mode occurs. If the event occurs, the power transmission side proceeds to the command branch phase (a command branch mode) (steps S207, S204). The power transmission side performs the command process on the communication mode (step S208), and returns to the command branch phase after the completion of the communication mode.

On the other hand, after the start of the normal power transmission, the power receiving side determines whether or not the event proceeding to the communication mode occurs. If the event occurs, the power receiving side proceeds to the command branch phase (steps S216, S214). Then, the power receiving side performs the command process on the communication mode (step S218).

Next, the power receiving side performs full-charge detection on the battery 94 in the load 90. If the full-charge is detected, the power receiving side transmits a full-charge detection command notifying the full-charge detection to the power transmission side (steps S217, S219).

When receiving the full-charge detection command from the power receiving side, the power transmission side stops the power transmission to the power receiving side. Then, the power transmission side starts the temporary power transmission, and proceeds to the authentication process phase (an authentication process mode) (steps S202, S203).

As shown in FIG. 4, in the embodiment, the authentication process section 100 on the power transmission side performs the authentication process on the power receiving device 40 before starting the normal power transmission (step S203). In addition, when the event proceeding to the communication mode in which the power transmission device 10 (the host 2 on the power transmission side) and the power receiving device 40 (the host 4 on the power receiving side) communicate with each other, after the start of the normal power transmission, the command process section 101 proceeds to the command branch phase, not to the authentication process phase, so as to perform the command process on the communication mode (steps S207, S204, S208). After the completion of the communication mode, the flow returns to the command branch phase.

Likewise, the authentication process section 120 on the power receiving side performs the authentication process on the power transmission device 10 before the start of the normal power transmission (step S213). In addition, when the event proceeding to the communication mode occurs after the start of the normal power transmission, the command process section 121 proceeds to the command branch phase, not to the authentication process phase, so as to perform the command process on the communication mode (steps S216, S214, S218).

Further, when the removal of an electronic apparatus or a foreign object, on the power receiving side, is detected (step S206), or when the full-charge of the battery 94 is detected (step S209), the power transmission control section 102 stops the normal power transmission. The authentication process section 100 performs the authentication process during a period of the temporary power transmission after the stop of the normal power transmission (step S203). After the authentication process phase, the authentication process section 100 proceeds to the command branch phase (step S204). If the removal, the foreign object, or the full-charge is detected, the power receiving side is powered off since the normal power transmission is stopped (step S211). Then, the power receiving side is powered on and reset since the temporary power transmission starts, and performs the authentication process (steps S212, S213). After the authentication process phase, the power receiving side proceeds to the command branch phase (step S214).

In this manner, the embodiment is based on the following phase transition. When an event, such as removal, foreign object, and full-charge detection, is detected, the power transmission is stopped. The temporary power transmission starts and then the authentication process (negotiation and setup processes) is performed. Thereafter, the flow proceeds to the command branch phase. According to the phase transition, the authentication process is performed even if an apparatus on the power receiving side is replaced with a foreign object after the detection of full-charge, for example. As a result, the safety and the reliability can be improved.

When the power transmission is stopped because of removal, foreign object, and full-charge detection, the power receiving side is powered off. A case, thus, arises in which data and commands stored in the register section 53 on the power receiving side disappear. For example, commands in the command register 134 and date in the data register 138 both of which are written by the host 4 for communication between the power transmission side and the power receiving side disappear when the power transmission is stopped. This may result in the convenience of the communication mode being lowered.

In this regard, the communication mode in the embodiment takes steps based on a phase transition different from that of the removal, foreign object, and full-charge detection. That is, when the event proceeding to the communication mode occurs, the step proceeds to the command branch phase without stopping the power transmission so as to perform the command process on the communication mode (steps S204, S208, S214, S218) whereas the power transmission is stopped and the step proceeds to the authentication process phase (steps S 202, S203, S212, S213) when the event—the removal, foreign object, and full-charge detection—occurs.

Accordingly, the power transmission is not stopped when the event proceeding to the communication mode occurs. The power receiving side, thus, is not powered off. As a result, the data and commands stored in the register section 53 on the power receiving side do not disappear. Consequently, the convenience of the communication mode can be prevented from being lowered. That is, both measures taken for preventing a replacement on the power receiving side and achieving an appropriate communication mode can be realized.

The event proceeding to the communication mode occurs in the following exemplified cases: a case where a communication request command is issued by the host 2 on the power transmission side to the host 4 on the power receiving side through the host interface I/F 27; and a case where the power transmission device 10 receives a communication interrupt command issued by the host 4 on the power receiving side.

When proceeding to the communication mode, the command process sections 101 and 121 set at least one of the transmission condition and the communication condition of contactless power transmission to a communication mode condition that is different from a condition for the normal power transmission. For example, when the normal power transmission is started, contactless power transmission is performed with the transmission condition for the normal power transmission. After the start of the normal power transmission, when the step proceeds from a normal power transmission mode (a charging mode) to the communication mode, the command process sections 101 and 121 switch the transmission and communication conditions for the normal power transmission to the transmission and communication conditions for the communication mode. The communication condition includes, for example, a communication method (such as a pulse width detection method, a current detection method, and an amplitude detection method) and a communication parameter (such as a frequency of the frequency modulation and a threshold of the load modulation).

Specifically, when the step proceeds to the communication mode, the driving frequencies (f1, f2) of the primary coil L1 are switched to driving frequencies for the communication mode. Alternatively, the driving voltage (VF) of the primary coil L1 may be switched to a driving voltage for the communication mode. The parameter (threshold) for the load state detection to detect data and a foreign object may be switched to a parameter for the communication mode.

In other word, in the normal power transmission mode (charging mode), transmission and communication conditions are set that can realize power transmission with the highest transmission efficiency, for example. In contrast, in the communication mode, it is preferable that transmission and communication conditions are set so as not to cause data transmission errors and the like, whereas it is not required to increase the transmission efficiency of the power transmission.

Because of this, in the communication mode, the transmission and communication conditions are switched to ones that give the reliability of communication higher priority than the transmission efficiency of power transmission. For example, the driving frequency and the driving voltage are lowered. Alternatively, a threshold serving as a communication parameter is changed or a communication method is changed to another method. Accordingly, the data transmission errors and the like can be reduced, whereby improving the reliability of the communication.

The communication and transmission conditions in the temporary power transmission period before the start of normal power transmission, for example, can be employed as the communication and transmission conditions for the communication mode. That is, commands (such as a communication interrupt request command, a full charge detection command, a recharge confirmation command,) are communicated in the normal power transmission period. Therefore, the communication is performed by using the communication condition information and transmission condition information received from the power receiving side. On the other hand, in the communication mode in which application data is communicated, since the power supply to the load 90 can be stopped, it is not required to use the communication condition information and transmission condition information received from the power receiving side. Instead, initial communication condition information and transmission condition information set as a default are used. The initial communication condition information and transmission condition information enable safer and reliable communication to be performed. That is, in the communication mode, the communication condition and the transmission condition in the temporary power transmission period are used. In the temporary power transmission period, a higher priority is given to the reliability of the communications than the transmission efficiency of the power transmission.

The recharge confirmation process section 109, when the normal power transmission is stopped due to the detection on the full charge of the battery 94, proceeds to a waiting phase after the detection of the full charge (a waiting period or a waiting mode after the detection of the full charge). In the waiting phase after the detection of the full charge, the recharge confirmation section 109 periodically (intermittently) performs the recharge confirmation process on the battery 94. The authentication process section 100 performs the authentication process in the temporary power transmission period that is periodically performed for the recharge confirmation in the waiting phase after the detection of the full charge. Thereafter, the authentication process section 100 proceeds to the command branch phase.

Since the normal power transmission is stopped after the detection of the full charge as described above, power can be saved. After the stop of the normal power transmission, the recharge confirmation process is periodically performed, so that it can be periodically confirmed whether or not the recharge is required again due to the voltage drop of the battery 94. Performing the authentication process before the recharge confirmation process can detect the replacement of an apparatus on the power receiving side even if it occurs after the detection of the full charge.

Specifically, the recharge confirmation process section 109 on the power transmission side sets a recharge confirmation flag to a set state (=1), at a time when the sep proceeds from the waiting phase after the detection of the full charge (waiting mode) to the authentication process phase. When the step proceeds to the recharge confirmation process phase from the authentication process phase through the command branch phase, the recharge confirmation process section 109 transmits a recharge confirmation command to the power receiving device 40.

Setting the recharge confirmation flag to the set state at the time when the step proceeds from the waiting phase after the detection of the full charge to the authentication process phase enables the recharge confirmation process section 109 to be properly branched to the command process for the recharge confirmation at the command branch after the authentication process. In addition, transmitting the recharge confirmation command to the power receiving device 40 in the recharge confirmation process enables the power receiving side to perform the recharge confirmation process.

When receiving a reply command notifying a charging state (whether or not the recharge is required, or a battery voltage or the like) of the battery 94, the recharge confirmation process section 109 determines whether or not the battery 94 needs to be recharged based on the reply command. If it is determined that the battery 94 needs to be recharged and the normal power transmission is started, the recharge confirmation flag is set to a reset state (=0). In contrast, if it is determined that the battery 94 does not need to be recharged, the step returns to the waiting phase after the detection of the full charge.

In this manner, the determination whether or not the recharge is required is done based on the reply command from the power receiving device 40. As a result, a proper determination whether or not the recharge is required can be done. If it is determined that the recharge is required, the recharge confirmation flag is set to the reset state. This prevents the following steps: the step returns to the temporary power transmission again and the authentication process is performed; and then, in the command branch, the step proceeds to a recharge confirmation process phase (a period or a mode in which the recharge confirmation process is performed) again. As a result, the step can proceed to the normal power transmission (recharging) mode. If it is determined that the recharge is not required, the step returns to the waiting phase after the detection of the full charge. This makes it possible to perform the recharge confirmation process on the battery 94 again, after a predetermined period, for example.

On the other hand, the recharge confirmation process section 129 on the power receiving side receives the recharge confirmation command from the power transmission device 10, which having proceed to the waiting phase after the detection of the full charge when the normal power transmission has been stopped due to the detection on the full charge of the battery 94. When receiving the recharge confirmation command, the recharge confirmation process section 129 transmits the reply command notifying the charging state of the battery 94 to the power transmission device 10. The reply command may notify only whether or not the recharge is required, or may notify a battery voltage and the like. If the power transmission device 10 periodically performs the temporary power transmission for the recharge confirmation in the waiting phase after the detection of the full charge, the recharge confirmation process section 129 on the power receiving side receives the recharge confirmation command and transmits the reply command in the temporary power transmission period for the recharge confirmation.

Accordingly, the power receiving side is powered on only in the temporary power transmission period for the recharge confirmation, after the detection of the full charge. In the period, the recharge confirmation command is received and the reply command is transmitted. As a result, power can be saved.

In FIG. 2, the host I/Fs 27 and 57 are provided on the power transmission side and the power receiving side respectively, so that communication can be performed between the host 2, on the power transmission side, and the host 4, on the power receiving side. In related art contactless power transmission systems, only ID authentication information can be communicated between the power transmission side and the power receiving side. Whereas, according to the structure shown in FIG. 2, application data can be communicated between an apparatus used on the power transmission side, such as a charger, and an apparatus used on the power receiving side, such as a cell-phone, by utilizing contactless power transmission. Accordingly, data communication between the apparatuses can be performed by utilizing a charging period, or the like. As a result, convenience of users can be significantly improved.

Specifically, referring to FIG. 2, a communication request command is written into the register section 23 by the host 2 through the host I/F 27. The communication request command requests communication between the host 2 on the power transmission side and the host 4 on the power receiving device. In this case, the controller 22 on the power transmission side proceeds to a communication mode, and transmits the communication request command to the power receiving device 40. In the communication mode, communication between the hosts 2 and 4 is performed.

On the other hand, when receiving the communication request command that requests communication between the hosts 2 and 4 from the power transmission device 10, the controller 52 on the power receiving side proceeds to the communication mode. For example, if the communication request command is transmitted from the power transmission side, receipt of the command is notified to the host 4, and an operation mode of the power receiving side also proceeds to the communication mode. As a result, the hosts 2 and 4 can communicate with each other.

Here, the communication request command includes, for example, an OUT transfer command and an IN transfer command. The OUT transfer command requests data transfer from the host 2 on the power transmission side to the host 4 on the power receiving side. When the OUT transfer command is written into the command register 114 of the register section 23, the controller 22 transmits the OUT transfer command to the power receiving device 40. Next, after an ACK command returned from the power receiving side is confirmed, a data transfer command (DATA0, DATA1) instructing data transfer is written into the command register 114. Then, when corresponding data is written into the data register 118, the data transfer command and the data are transmitted to the power receiving device 40.

On the other hand, the IN transfer command requests data transfer from the host 4 on the power receiving side to the host 2 on the power transmission side. When the IN transfer command is written into the command register 114, the controller 22 transmits the IN transfer command to the power receiving device 40. Next, when the data transfer command and data are received from the power receiving device 40, the received data is written into the data register 118. In addition, the receipt of the data transfer command is notified to the host 2 by using the interrupt register 116.

In FIG. 2, even though when receiving an interrupt command issued by the host 4 on the power receiving side to request communication, the controller 22 proceeds to the communication mode. Specifically, when the host 4 issues the interrupt command (INT) to request communication, the receipt of the command is notified to the host 2 by the interrupt register 116 and the operation mode proceeds to the communication mode. Accordingly, the controller 22 can proceed to the communication mode by not only the communication request from the host 2 on the power transmission side, but also by the communication request from the host 4 on the power receiving side. The register section 53 on the power receiving side also includes the command register 134 into which the command issued by the host 4 on the power receiving side is written. When the interrupt command (INT) to request communication to the host 2 on the power transmission side is written into the command register 134 by the host 4 on the power receiving side, the controller 52 on the power receiving side proceeds to the communication mode.

### 3. Operation

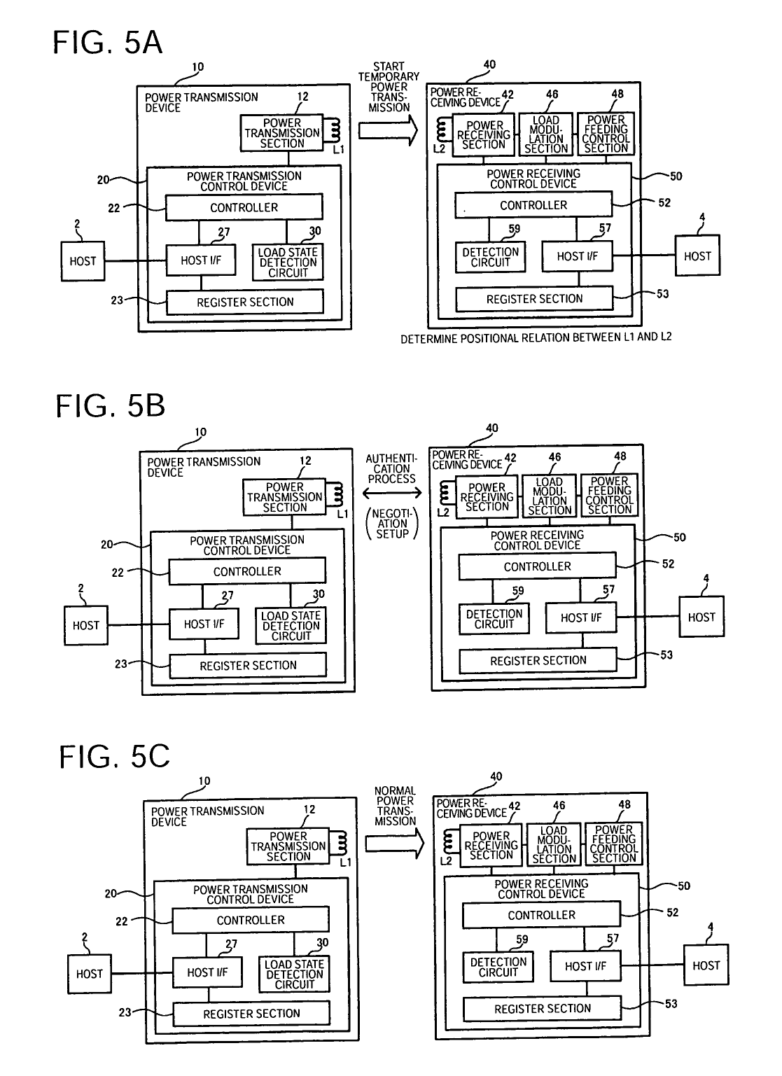

Next, operations of the embodiment will be described with reference to FIG. 2, and FIGS. 5(A) to 9(C).

As shown in FIG. 5(A), first, the power transmission device 10 starts the temporary power transmission (power transmission for detecting a position) before starting the normal power transmission. With this temporary power transmission, a power supply voltage is supplied to the power receiving device 40, so that the power receiving device 40 is powered on. The power receiving device 40, for example, determines whether or not a positional relation between the primary coil L1 and the secondary coil L2 is appropriate.

As shown in FIG. 5(B), if it is determined that the positional relation between the primary coil L1 and the secondary coil L2 is appropriate, the authentication process is performed while the temporary power transmission condition is maintained between the power transmission side and the power receiving side. Specifically, the negotiation process and the setup process, which are described later, are performed, for example. In the processes, various kinds of information such as the transmission condition and the communication condition are set in the information registers 110 and 130.

After the authentication process is appropriately performed and completed between the power transmission side and the power receiving side, a start frame is transmitted to the power transmission side from the power receiving side, for example. As a result, the power transmission side starts the normal power transmission to the power receiving side to start charging the battery 94 in the load 90 and the like, as shown in FIG. 5(C). The start of the normal power transmission allows the power transmission side to accept the communication request from the host 2 on the power transmission side.

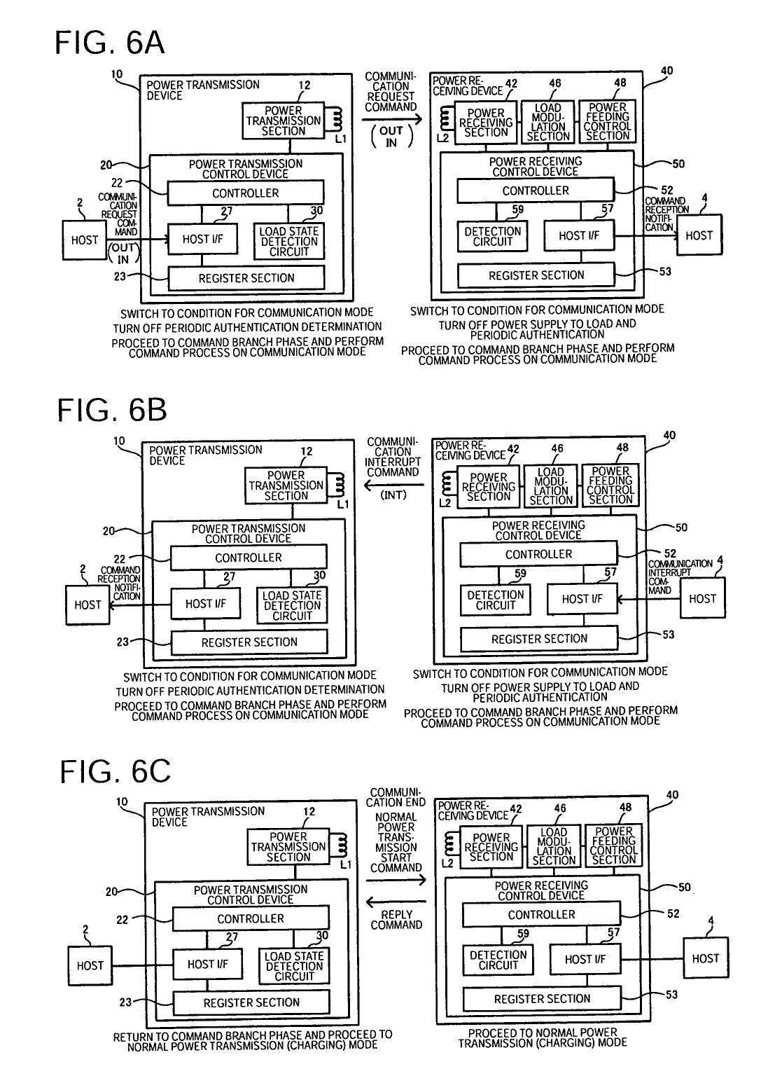

For example, in FIG. 6(A), the host 2 on the power transmission side issues the communication request command such as the OUT transfer and the IN transfer. The communication command is written into the register section 23 (command register) through the host I/F 27. As a result, the power transmission side proceeds to the communication mode (step S207 in FIG. 4). Specifically, the transmission and communication conditions for the normal power transmission are switched to ones for the communication mode. In addition, the determination process on the periodic authentication is turned off. Then, the step proceeds to the command branch phase to perform the command process on the communication mode (steps S204, S208). In the command process on the communication mode, the power transmission side transmits the communication request command (command packet) such as the OUT transfer and the IN transfer to the power receiving side by contactless power transmission (frequency modulation).

When receiving the communication request command, the power receiving side proceeds to the communication mode (step S216). Specifically, the transmission and communication conditions for the normal power transmission are switched to ones for the communication mode. In addition, the power supply to the load 90 is turned off, and a sending process of the periodic authentication is turned off. Turning off the power supply to the load 90 can prevent the load modulation for data communication from being suffered by the fluctuation of the load 90 in the communication mode. Then, the step proceeds to the command branch phase to perform the command process on the communication mode (steps S214, S218).

On the other hand, in FIG. 6(B), the host 2 on the power receiving side issues the communication interrupt command to request communication with the host 4 on the power transmission side. The communication interrupt command is written into the register section 53 (command register) through the host I/F 57. As a result, the power receiving side proceeds to the communication mode (step S216). Specifically, the conditions are switched to ones for the normal power transmission, the power supply to the load is turned off, the periodic authentication is turned off, and the step proceeds to the command branch phase to perform the command process on the communication mode (steps S214, S218). In the command process, the power receiving side transmits the communication interrupt command to the power transmission side by contactless power transmission (load modulation).

When receiving the communication interrupt command, the power transmission side proceeds to the communication mode (step S207). Specifically, the conditions are switched to ones for the communication mode, the determination on the periodic authentication is turned off, and the step proceeds to the command branch phase to perform the command process on the communication mode (steps S204, S208).

As shown in FIG. 6(C), upon completion of the communication mode, the power transmission side returns to the command branch phase, and transmits the normal power transmission command. When receiving the normal power transmission reply command from the power receiving side, the power transmission side starts the normal power transmission, and proceeds to the normal power transmission (charging) mode. Once the normal power transmission starts, the power receiving side proceeds to the normal power transmission mode.

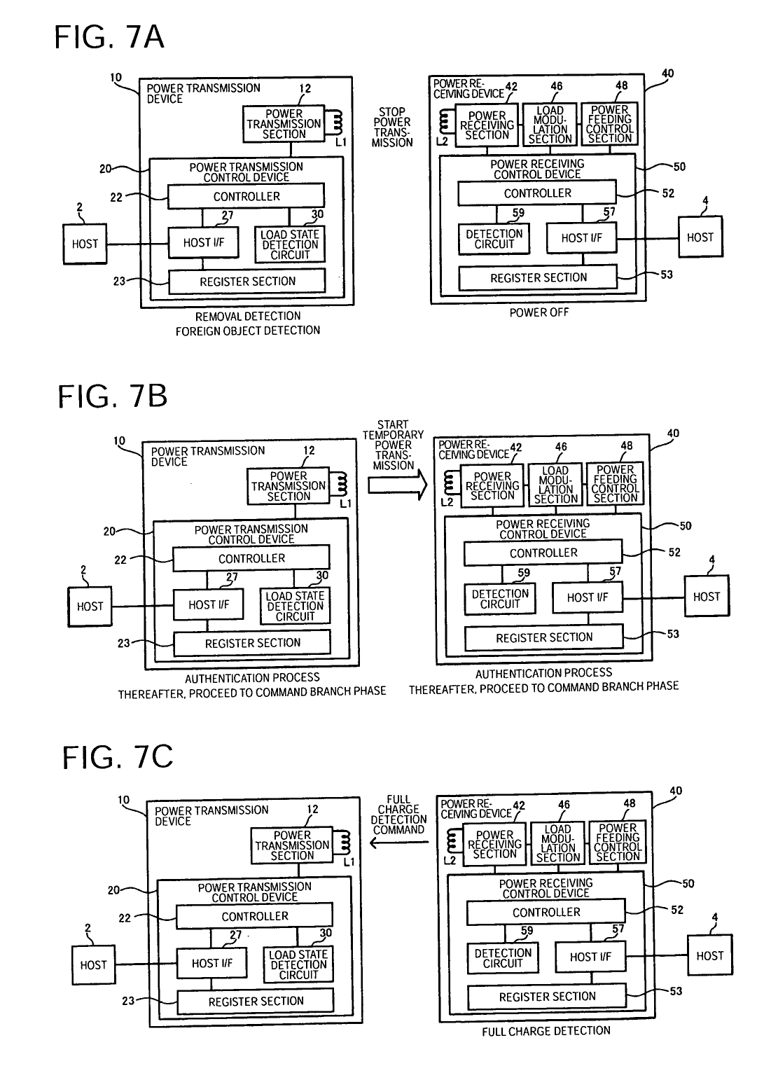

As shown in FIG. 7(A), the power transmission side stops the power transmission if the removal of an electronic apparatus on the power receiving side or a foreign object is detected (step S206). As a result, the power receiving side is powered off. As shown in FIG. 7(B), the power transmission side, then, starts the temporary power transmission, performs the authentication process, and then proceeds to the command branch phase (steps S202, S203, S204). Upon starting of the temporary power transmission, the power receiving side having been powered on and reset performs the authentication process, and then proceeds to the command branch phase (steps S212, S213, S214). If the electronic apparatus on the power receiving side remains removed or the foreign object remains inserted, the step proceeds to the waiting phase after the detection of the removal so as to perform placement detection on the electronic apparatus on the power receiving side.

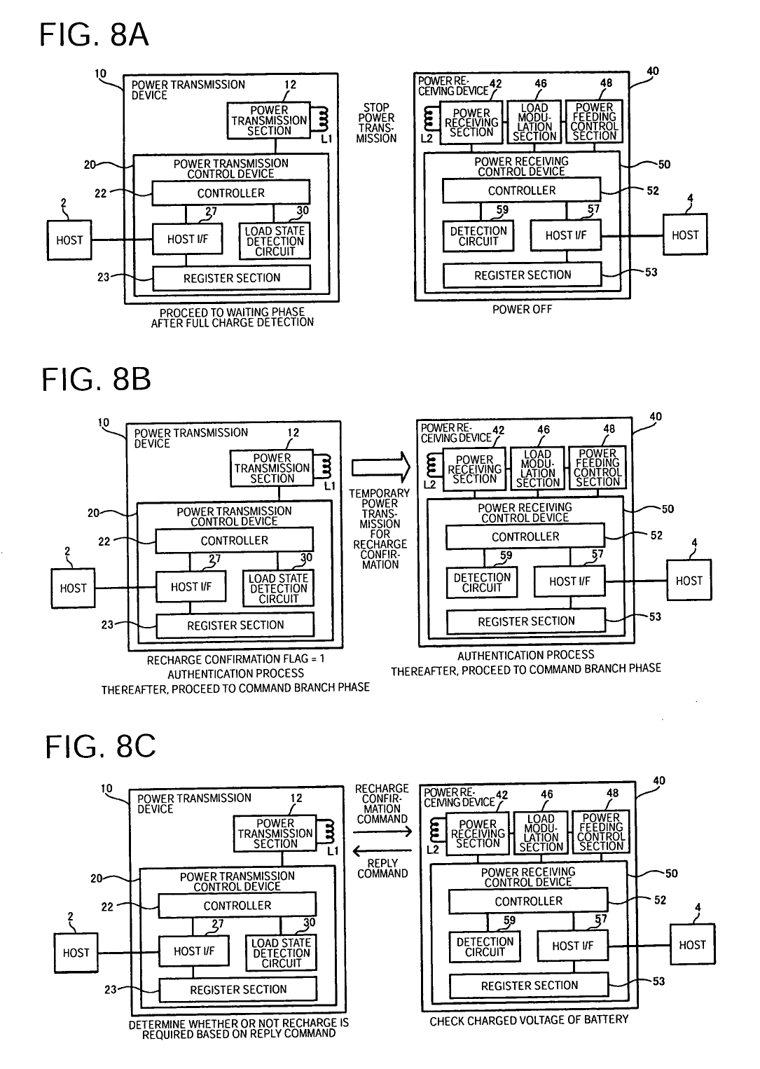

As shown in FIG. 7(C), when detecting the full charge of the battery 94, the power receiving side transmits the full charge detection command (full charge notifying command) to the power transmission side (step S219). As shown in FIG. 8(A), when receiving the full charge detection command (step S209), the power transmission side proceeds to the waiting phase after the detection of the full charge. Thereafter, the power transmission side stops the power transmission to the power receiving side, resulting in the power receiving side being powered off. As a result, power is saved.

As shown in FIG. 8(B), in the waiting phase after the detection of the full charge, the power transmission side sets the recharge confirmation flag to “1”, and periodically performs the temporary power transmission for the recharge confirmation. As a result, the power transmission side and the power receiving side perform the authentication process, and then proceed to the command branch phase. The authentication process performed as described above enables the replacement on the power receiving side in the waiting mode after the detection of the full charge to be detected.

Since the recharge confirmation flag is set to “1” in FIG. 8(B), the recharge confirmation process is performed in the command branch phase. As shown in FIG. 8(C), the power transmission side transmits the recharge confirmation command to the power receiving side. The power receiving side confirms the charging voltage of the battery 94, and transmits a reply command to notify the confirmation result (whether or not recharge is required, or a charging voltage) to the power transmission side. Based on the reply command, the power receiving side determines whether or not the battery 94 needs to be recharged.

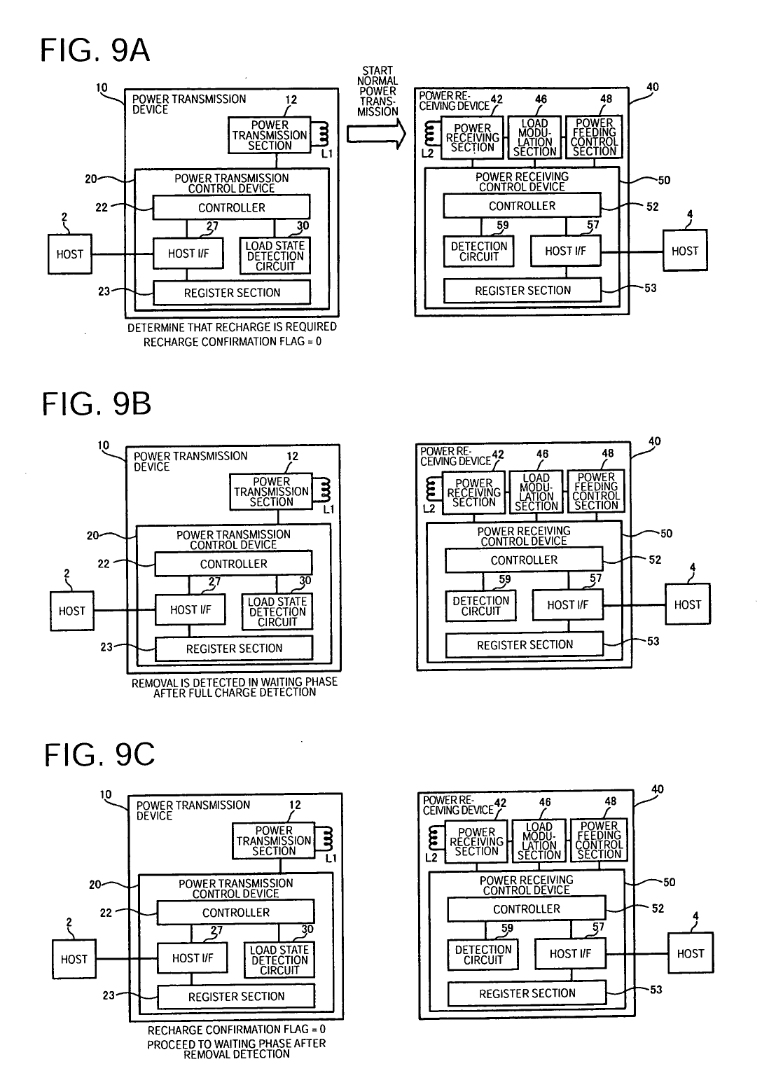

As shown in FIG. 9(A), when determining that the recharge is required, the power transmission side resets the recharge confirmation flag to “0”, and transmits the normal power transmission command to recharge the battery 94. When receiving the normal power transmission reply command from the power receiving side, the power transmission side starts the normal power transmission. Since the recharge confirmation flag is reset to “0”, the step does not proceed to the recharge confirmation process in the command branch phase.

When determining that the recharge is not required, the power transmission side does not reset the recharge confirmation flag to “0”, and returns to the waiting mode after the detection of the full charge shown in FIG. 8(A). Until when it is determined that the recharge is required, the processes shown in FIGS. 8(A) to 8(C) are repeated.

If the removal of an electronic apparatus on the power receiving side is detected as shown in FIG. 9(B), the power transmission side resets the recharge confirmation flag to “0”, and proceeds to the waiting phase after the detection of the removal to wait that the electronic apparatus on the power receiving side is placed again, as shown in FIG. 9(C).

### 4. Process Sequence of Contactless Power Transmission

As contactless power transmission is widely used, it is expected that various types of secondary coils for the power receiving side are available in markets. That is, since electric apparatuses, such as cell-phones, serving as the power receiving side have a wide variety of shapes and sizes, secondary coils installed in the power receiving devices of the electric apparatuses also have a wide variety of shapes and sizes. In addition, electronic apparatuses need a wide variety of electrical energy (wattages) and output voltages for contactless power transmission. As a result, the secondary coils also have a wide variety of inductances and the like.

On the other hand, in contactless power transmission, power can be transmitted even if the shapes and the sizes of the primary coil and the secondary coil are not completely compatible. In this regard, in a charge using a wired cable, such case can be prevented by refining a shape and the like of cable connectors. However, in contactless power transmission, such refinements are hard to be made.

Currently, each supplier employs an individual method to realize contactless power transmission.

However, in order to encourage broad use of contactless power transmission as well as ensure the safety in the use, it is preferable to realize a process sequence of contactless power transmission with high general versatility.

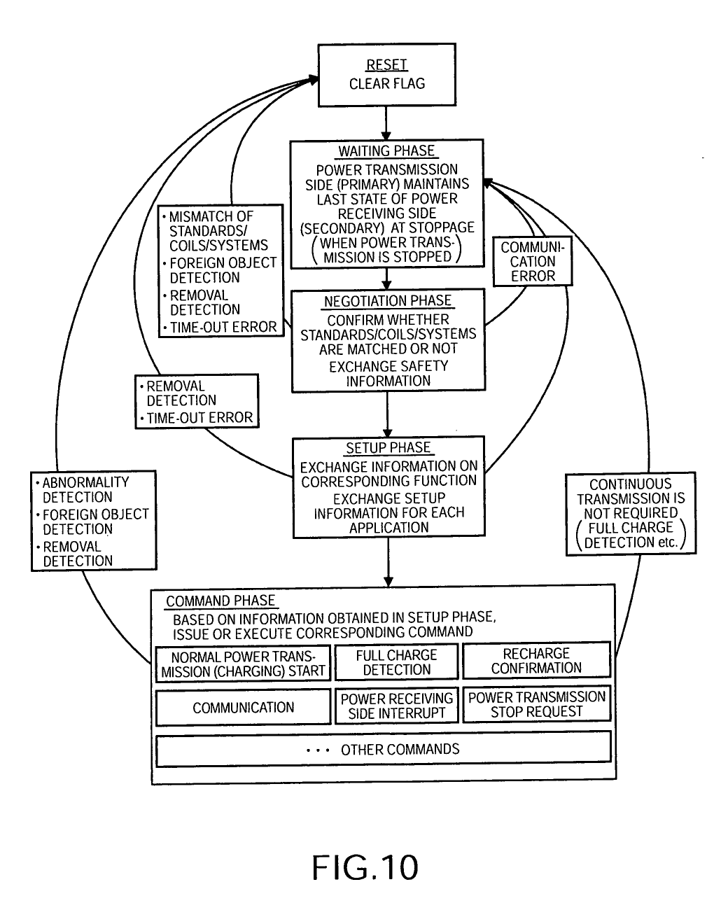

FIG. 10 schematically shows a process sequence of contactless power transmission realized by the embodiment.

In the process sequence, the sequence proceeds to a waiting phase after a reset state. In the reset state, various flags maintained on the power transmission side (the primary side) and the power receiving side (the secondary side) are cleared. Here, the flags represent conditions of the power transmission device and the power receiving device (a power transmission state, a full charge state, a recharge confirmation state, and the like), and kept in the register sections of the devices.

In the waiting phase, the power transmission side (the primary side) maintains the last state of the power receiving side (the secondary side) at the time of stoppage (at the time at which power transmission is stopped). For example, if a full charge of the battery is detected, the power transmission side and the power receiving side proceed to the waiting phase after the detection of the full charge. In this case, since the battery needs to be recharged by detecting a battery voltage drop, the power transmission side stores that the power transmission stop is due to the full charge detection. Specifically, the recharge confirmation flag is maintained in a set state without clearing it so as to periodically confirm whether or not the recharge is required.

In the waiting phase, power transmission from the power transmission side to the power receiving side is stopped. As a result, a power supply voltage is not supplied to the power receiving side, so that the power receiving side is in a stop state while a power supply voltage is supplied to the power transmission side, so that the power transmission side is in an operating state. As described above, the power receiving side stops the operation in the waiting phase, thereby achieving low power consumption. At this time, the power transmission side maintains flags for various states without clearing them, so that the power transmission side can perform various processes by using the flags after the waiting phase.

The power transmission side and the power receiving side proceed to a negotiation phase after the waiting phase. In the negotiation phase, a negotiation process is performed in which a match of standards/coils/systems is confirmed and safety information is exchanged. Specifically, the power transmission side and the power receiving side exchange standard/coil/system information so as to confirm whether or not the standards/coils/systems are compatible. In addition, for example, safety threshold information for detecting foreign objects and the like is transmitted from the power receiving side to the power transmission side so as to exchange safety information. In the negotiation process, the following are confirmed: whether or not information can be communicated between the power transmission side and the power receiving side; whether or not the communicated information is adequate; whether or not a load state on the power receiving side is appropriate (undetection of foreign objects); and the like.

The sequence proceeds to the reset state, and the various flags are cleared, if any of the following cases occur in the negotiation process: a mismatch of standards/coils/systems is determined; a foreign object is detected; a removal of the apparatus is detected; and a timeout error occurs. On the other hand, if a communication error or the like occurs, the sequence proceeds to the waiting phase, for example, and the flags are not cleared.

The power transmission side and the power receiving side proceed to the setup phase after the negotiation phase. In the setup phase, a setup process is performed in which setup information such as corresponding function information and setup information for each application is transferred. For example, based on a result of the negotiation process, the authentication process is performed, and then the transmission condition is specified. Specifically, if the power receiving side transmits transmission condition information such as the driving voltage as well as the driving frequency of the coil to the power transmission side, the power transmission side sets a transmission condition such as the driving voltage and the driving frequency of the coil for normal power transmission based on the received transmission condition information. In addition, information on corresponding functions and setup information different in different upper applications are also exchanged in the setup process. Specifically, the following information is exchanged in the setup process: threshold information (e.g., threshold information for data communication and foreign object detection) for detecting a load state on the power receiving side after the start of normal power transmission; kinds of commands that the power transmission side and the power receiving side are able to issue or execute in the command phase; and additional corresponding functions such as a communication function and a periodic authentication function. Accordingly, setup information can be exchanged that is different in different applications such as kinds (a cell-phone, audio equipment, and the like) and models of electric apparatuses.

If a removal of the apparatus is detected or a timeout error occurs in the setup process, the sequence proceeds to the reset state. On the other hand, if a communication error and the like occur, the sequence proceeds to the waiting phase.

The power transmission side and the power receiving side proceed to the command phase after the setup phase. In the command phase, a command process is performed based on the information obtained in the setup process. That is, a corresponding command (confirmed that it can correspond, in the setup process) is issued or executed. Examples of the command executed in the command process include: a normal power transmission (charging) start command, a full charge detection (notifying) command, a recharge conformation command, a communication command, a power receiving side interrupt command, and a power transmission stop request command.

For example, when normal power transmission is ready after the negotiation process and the setup process, the power transmission side transmits (issues) the normal power transmission (charging) start command to the power receiving side. Then, the power receiving side receives the command and transmits a reply command to the power transmission side. As a result, the normal power transmission starts. If a full charge is detected on the power receiving side after the start of the normal power transmission, the power receiving side transmits the full charge detection command to the power transmission side.

If continuous power transmission is not required, such as the full charge detection, the sequence proceeds to the waiting phase after the detection of the full charge. After going through the negotiation process and the setup process again, the power transmission side transmits the recharge confirmation command to the power receiving side. Then, the power receiving side checks a battery voltage so as to determine whether or not a recharge is required. If the recharge is required, the recharge confirmation flag is reset, and the sequence proceeds to the negotiation phase. Then, the authentication process and the setup process are performed. Thereafter, the power transmission side issues the normal power transmission start command. As a result, the normal power transmission restarts. On the other hand, if the recharge is not required, the recharge confirmation flag is maintained in the set state. Then, the sequence returns to the waiting phase after the detection of the full charge.

If any abnormality, a foreign object, or a removal is detected in the command process, the sequence proceeds to the reset state.

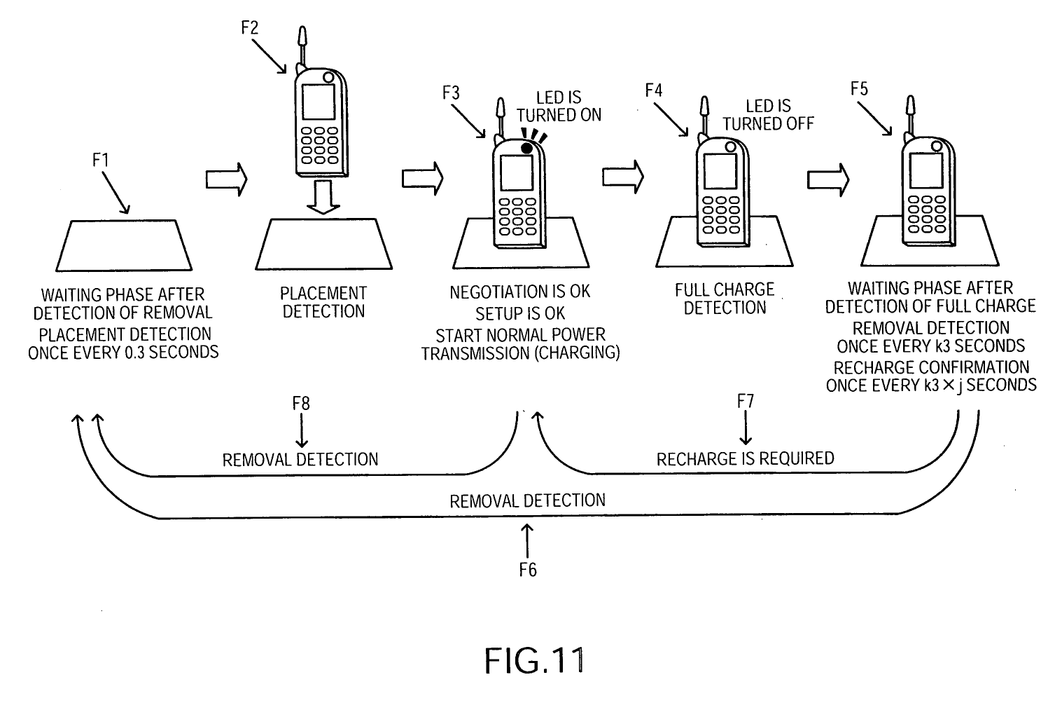

The process sequence according to the embodiment is more specifically described with reference to FIG. 11. In the waiting phase after the detection of the removal shown in F1, placement detection is performed once every k1 seconds, for example. As shown in F2, if a placement (an installation) of the electronic apparatus is detected, the negotiation process and the setup process are performed. As shown in F3, if the negotiation process and the setup process are normally ended, and the normal power transmission start command is issued in the command process, the normal power transmission starts so as to start charging the electronic apparatus. As shown in F4, if a full charge is detected, an LED of the electronic apparatus is turned off. Then, the process sequence proceeds to the waiting phase after the detection of the full charge as shown in F5.

In the waiting phase after the detection of the full charge, removal detection is performed once every k3 seconds and a recharge is confirmed once every k3×j seconds. Then, in the waiting phase after the detection of the full charge, if a removal of the electronic apparatus is detected as shown in F6, the process sequence proceeds to the waiting phase after the detection of the removal. On the other hand, in the waiting phase after the detection of the full charge, if it is determined that a recharge is required by the recharge confirmation as shown in F7, the negotiation process and the setup process are performed. Then, the normal power transmission is restarted so as to start recharging the battery. If a removal of the electric apparatus is detected during the normal power transmission as shown in F8, the process sequence proceeds to the waiting phase after the detection of the removal.

The system information transferred in the negotiation phase shows methods for detecting load states on the power transmission side and the power receiving side. Examples of the method for detecting the load state include the pulse width detection method (the phase detection method), the current detection method, the peak voltage detection method, and the combination thereof. The system information shows that which one out of the methods is employed by the power transmission side and the power receiving side.

The foreign object threshold is threshold information in terms of safety. The foreign object threshold is, for example, stored in the power receiving side, and is transmitted from the power receiving side to the power transmission side before the start of normal power transmission. The power transmission side, based on the foreign object threshold, performs first foreign object detection that is foreign object detection before the start of normal power transmission. For example, if a load state on the power receiving side is detected by the pulse width detection method, a threshold of a pulse width count value is transmitted from the power receiving side to the power transmission side as a foreign object threshold. Based on the threshold of the count value, the power transmission side performs the first foreign object detection by the pulse width detection method. In this way, in the embodiment, the threshold information for detecting a load state on the power receiving side before the start of normal power transmission is transmitted to the power transmission side from the power receiving side in the negotiation process. On the other hand, the threshold information for detecting a load state on the power receiving side after the start of the normal power transmission is, for example, transmitted to the power transmission side from the power receiving side in the setup process.

According to the process sequence of the embodiment, the compatibility of standards/coils/systems is determined and the minimum safety information is exchanged in the negotiation process. In addition, in the negotiation process, the possibility of communication and the adequacy of the communication information are determined as well as the propriety of a load state of the power receiving side is determined.

In the setup process, a transmission condition required for the normal power transmission is set. For example, the driving voltage and the driving frequency of the coil are set. In addition, threshold information for detecting a load state after the start of normal power transmission is transferred, and information on an additional corresponding function and setup information required for each upper application are exchanged in the setup process.

After going through the setup process and the negotiation process, the process sequence proceeds to the command phase so as to perform the command process. That is, a command confirmed that it is available in the negotiation process and the setup process is issued or executed in the command process.

Accordingly, the minimum information required for securing the compatibility and the safety of the system is exchanged in the negotiation process, and setup information different in different applications is exchanged in the setup process. As a result, if information on the power transmission side is not compatible with that of the power receiving side, it is excluded in the negotiation process, whereby the setup information having a large volume of information needs not to be transferred. In the negotiation process, only the minimum information is transferred, whereby an amount of transferred information can be reduced. Thus, the negotiation phase is ended in a short time, allowing achieving an efficient process.

Each apparatus on the power transmission side and the power receiving side can perform minimum contactless power transmission by the negotiation process, and each apparatus can expand the functions by exchanging the setup information. Each apparatus makes the minimum setting required for a contactless power transmission system in the negotiation process, and the system can be optimized in the setup process. As a result, a flexible system can be realized.

The power transmission side receives threshold information and system information from the power receiving side, and can realize contactless power transmission and foreign object detection only by setting the received threshold information and the system information. Therefore, the processes on the power transmission side can be simplified. In this case, the power receiving side transmits coil information of an appropriate combination and threshold information to the power transmission side, so that appropriate and safe contactless power transmission can be realized

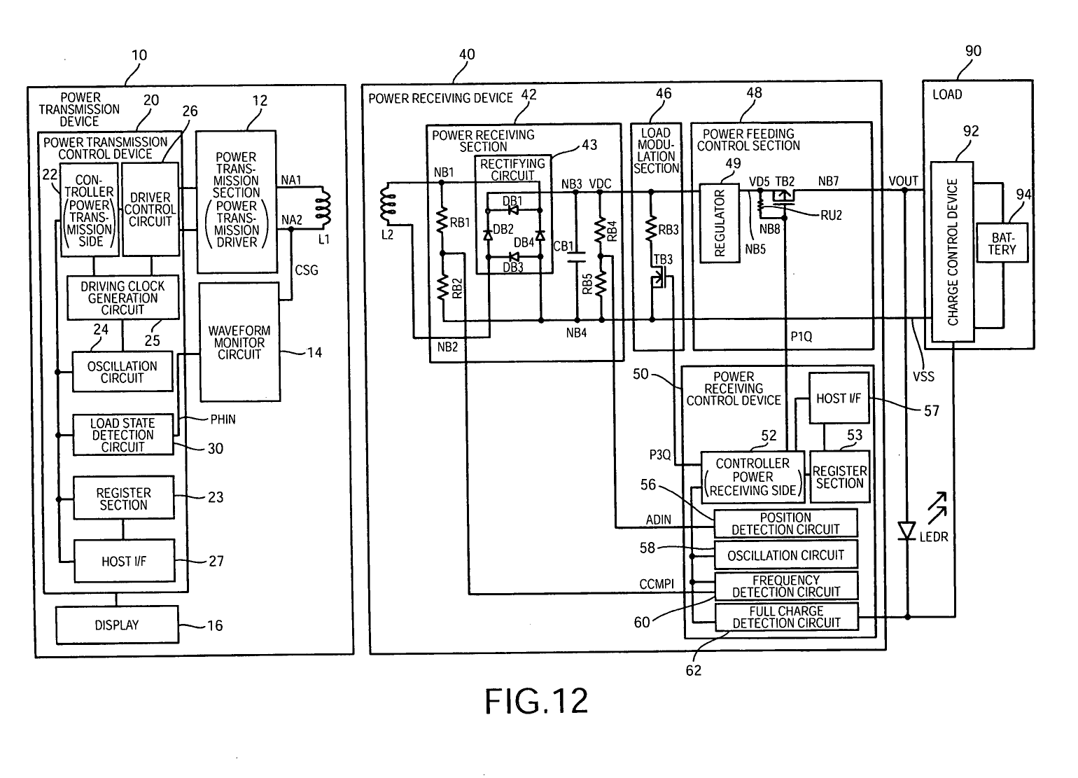

### 5. Specific Structural Example A detailed structural example of the embodiment is shown in FIG. 12. Hereinafter, the elements described in FIG. 2 are indicated by the same numerals and the description thereof is omitted.

A waveform monitor circuit 14, based on a coil terminal signal CGS of the primary coil L1, generates an induced voltage signal PHIN for a waveform monitor. For example, the coil terminal signal CGS that is an induced voltage signal of the primary coil L1 may exceed a maximum rating voltage of an IC of the power transmission control device 20 or have a negative voltage. The waveform monitor circuit 14 receives the coil terminal signal CGS so as to generate the induced voltage signal PHIN for a waveform monitor and outputs it to, for example, a terminal for a waveform monitor of the power transmission control device 20. The induced voltage signal PHIN is capable of being detected as a waveform by the load state detection circuit 30 of the power transmission control device 20. A display 16 displays various states (in power transmitting, ID authenticating, and the like) of the contactless power transmission system with colors, images, and the like.

An oscillation circuit 24 generates a clock for the primary side. A driving clock generation circuit 25 generates a driving clock defining the driving frequency. A driver control circuit 26, based on the driving clock from the driving clock generation circuit 25 and a frequency setting signal from the controller 22, generates a control signal having a desired frequency. Then, the control signal is outputted to first and second power transmission drivers of the power transmission section 12 so as to control the first and the second power transmission drivers.

The load state detection circuit 30 shapes a waveform of the induced voltage signal PHIN so as to generate a waveform shaped signal. For example, the load state detection circuit 30 generates a waveform shaped signal (a pulse signal) of a square wave (a rectangular wave). The square waveform becomes active (e.g., an H level) if the signal PHIN is beyond a given threshold voltage. The load state detection circuit 30, based on the waveform shaped signal and the driving clock, detects pulse width information (a pulse width period) of the waveform shaped signal. Specifically, the load state detection circuit 30 receives the waveform shaped signal and the driving clock from the driving clock generation circuit 25 so as to detect the pulse width information of the waveform shaped signal. As a result, the pulse width information of the induced voltage signal PHIN is detected.

As for the load state detection circuit 30, the detection method is not limited to the pulse width detection method (phase detection method). Various methods such as the current detection method and the peak voltage detection method can be employed.

The controller 22 (the power transmission control device), based on a detection result in the load state detection circuit 30, determines a load state (load fluctuation, a degree of the load) of the power receiving side (the secondary side). For example, the controller 22, based on the pulse width information detected in the load state detection circuit 30 (a pulse width detection circuit), determines a load state on the power receiving side so as to detect, for example, data (a load), a foreign object (metal), a removal (placement and removal), and the like. That is, a pulse width period that is pulse width information of the induced voltage signal varies in accordance with the variation of the load state on the power receiving side. The controller 22 can detect load fluctuation on the power receiving side based on the pulse width period (a count value obtained by measuring the pulse width period).

The power receiving section 42 converts an alternating induced voltage of the secondary coil L2 into a direct-current voltage. This conversion is performed by a rectifying circuit 43 included in the power receiving section 42.

The load modulation section 46 performs a load modulation process. Specifically, when desired data is transmitted from the power receiving device 40 to the power transmission device 10, a load on the load modulation section 46 (the secondary side) is variably changed so as to vary a signal waveform of the induced voltage of the primary coil L1. Therefore, the load modulation section 46 includes a resistance RB3 and a transistor TB3 (an N-type CMOS transistor) that are provided in series between the nodes NB3 and NB4. The transistor TB3 is on/off-controlled by a signal P3Q from the controller 52 of the power receiving control device 50. When the transistor TB3 is on/off-controlled so as to perform a load modulation, a transistor TB2 of the power feeding control section 48 is turned off. As a result, the load 90 is in a state of not being electrically coupled to the power receiving device 40.

The power feeding control section 48 controls power feeding to the load 90. A regulator 49 regulates a voltage level of a direct-current voltage VDC obtained by the conversion in the rectifying circuit 43 so as to generate a power supply voltage VD5 (e.g., 5V). The power receiving control device 50 operates with a supply of the power supply voltage VD5, for example.

The transistor TB2 (a P-type CMOS transistor, a power feeding transistor) is controlled by a signal P1Q from the controller 52 of the power receiving control device 50. Specifically, the transistor TB2 is turned off during the negotiation process and the setup process while turned on after the start of normal power transmission.

A position detection circuit 56 determines whether or not a positional relation between the primary coil L1 and the secondary coil L2 is appropriate. An oscillation circuit 58 generates a clock for the secondary side. A frequency detection circuit 60 detects frequencies (f1, f2) of a signal CCMPI. A full charge detection circuit 62 detects whether or not the battery 94 (a secondary battery) of the load 90 is in a full charge state (a charged state).

The load 90 may include a charge control device 92 controlling a charge and the like of the battery 94. The charge control device 92 (a charge control IC) can be realized by an integrated circuit device or the like. The battery 94 itself may have a function of the charge control device 92, as a smart battery.

### 6. Specific Operational Example

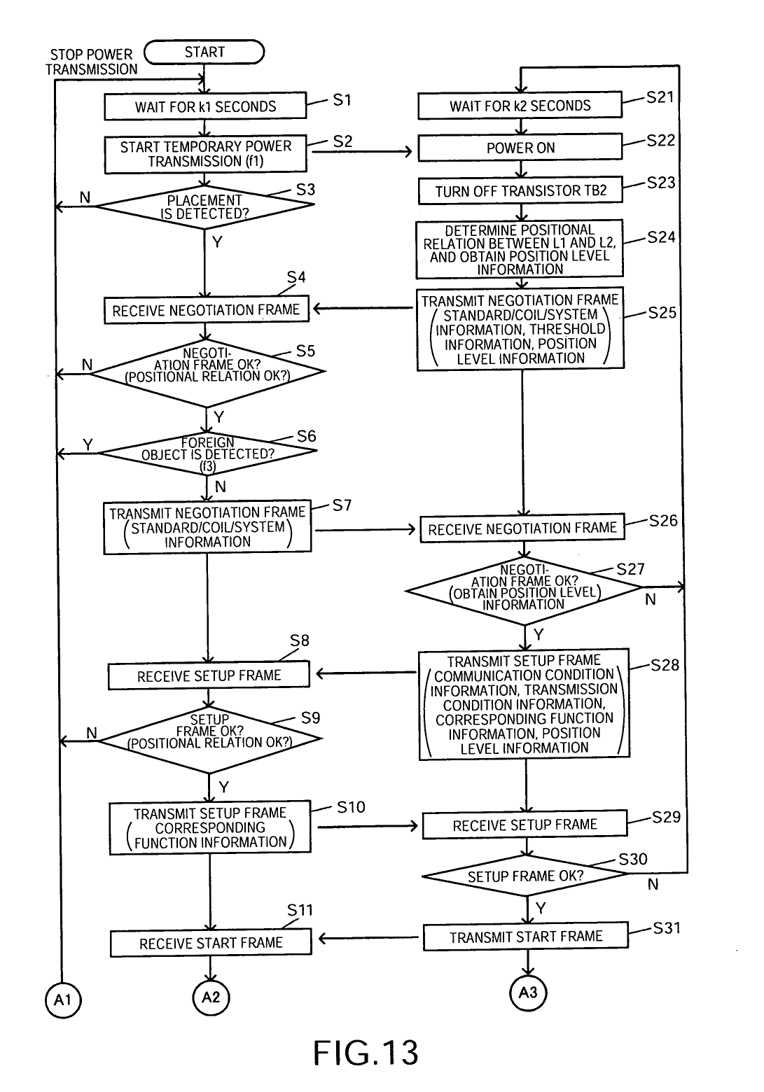

Next, operations on the power transmission side and the power receiving side will be described in detail with reference to flowcharts shown in FIGS. 13 to 15. In FIG. 13, a process flow on the power transmission side is shown in a left column while that on the power receiving side is shown in a right column.

As shown in FIG. 13, upon being turned on after applying a power source, the power transmission side performs the temporary power transmission before the start of normal power transmission (step S2), for example, after a wait of k1 seconds (step S1). The temporary power transmission is interim power transmission for placement detection, position detection, and the like. That is, the power is transmitted for detecting whether or not the electric apparatus is placed on the charger, and, if the electric apparatus is placed, whether or not the electric apparatus is placed on an appropriate position. A driving frequency (a frequency of a driving clock from the driving clock generation circuit) in the temporary power transmission is set to f1, for example.

The temporary power transmission from the power transmission side turns the power receiving side on (step S22). As a result, the power receiving control device 50 is powered on and reset. The power receiving control device 50 sets the signal P1Q to the H level. As a result, the transistor TB2 (power feeding transistor) of the power feeding control section 48 is turned off (step S23), so that the electrical connection with the load 90 is cut off.

Next, the power receiving side determines, by using the position detection circuit 56, a positional relation (a position level) between the primary coil L1 and the secondary coil L2, and obtains position level information or positional relation information (step S24).

Then, regardless whether or not the positional relation is appropriate, the power receiving side makes a negotiation frame so as to transmit it to the power transmission side (step S25). Specifically, the negotiation frame is transmitted by the load modulation. The negotiation frame includes hardware related information such as a matching code such as standard information and coil information, system information (load state detection method), and threshold information (threshold for detecting a load state) stored in the register section 53 on the power receiving side. In addition, the position level information (positional relation information) obtained in the step S24 is additionally included in the negotiation frame.

When receiving the negotiation frame (step S4), the power transmission side verifies the negotiation frame (step S5). Specifically, it is determined that whether or not the standard/coil/system information stored in the register section 23 on the power transmission side and the received standard/coil/system information from the power receiving side are a combination within an application range. Based on the position level information additionally included in the negotiation frame, the positional relation between the primary coil L1 and the secondary coil L2 is also determined. Then, if it is determined that the negotiation frame is appropriate, foreign object detection is performed (step S6).

Specifically, the power transmission side sets the driving frequency to a frequency f3 for detecting a foreign object. Then, based on the threshold information (safety threshold information) received from the power receiving side, the first foreign object detection before the start of normal power transmission is performed so as to determine whether or not a load state of the power receiving side is appropriate. For example, a foreign object detection enable signal is activated so as to instruct the load state detection circuit 30 to start detecting a foreign object. The foreign object detection can be realized by comparing, for example, load state detection information (pulse width information) from the load state detection circuit 30 with a threshold (META) for detecting a load state received from the power receiving side. After the foreign object detection period ends, the power transmission side returns the driving frequency to the frequency f1.

If the negotiation frame is determined to be inappropriate in the step S5 or a foreign object is detected in the step S6, the power transmission side stops power transmission so as to return to the step S1.

Next, the power transmission side makes a negotiation frame so as to transmit it to the power receiving side (step S7). The negotiation frame includes, for example, standard information, coil information, and system information stored in the register section 23 on the power transmission side.

When receiving the negotiation frame (step S26), the power receiving side verifies the negotiation frame (step S27). Specifically, it is determined whether or not the standard/coil/system information stored in the register section 53 on the power receiving side and the received standard/coil/system information from the power transmission side are a combination within an application range. In addition, the power receiving side determines again a positional relation between the primary coil L1 and the secondary coil L2 so as to obtain the position level information. Then, if it is determined that the negotiation frame is appropriate, the power receiving side generates a setup frame so as to transmit it to the power transmission side (step S28). The setup frame includes communication condition information, transmission condition information, corresponding function information, and position level information. The communication condition information includes the communication method, the communication parameter, and the like. The transmission condition information includes the driving voltage and the driving frequency of the primary coil, and the like. The corresponding function information represents an additional function for each application, and the like. If the setup frame is not appropriate, the power receiving side returns to the step S21.

When receiving the setup frame (step S8), the power transmission side verifies the setup frame (step S9). If the setup frame from the power receiving side is appropriate, the power transmission side makes a setup frame on the power transmission side so as to transmit it to the power receiving side (step S10). On the other hand, if the negotiation frame is not appropriate, the power transmission side stops power transmission so as to return to the step S1.

When receiving the setup frame (step S29), the power receiving side verifies the setup frame (step S30). If the setup frame is appropriate, the power receiving side makes a start frame so as to transmit it to the power transmission side (step S31). On the other hand, if the setup frame is not appropriate, the power receiving side returns to the step S21.

If the start frame is transmitted, the power transmission side and the power receiving side proceed to the command branch. That is, a command determination is performed so as to branch into one of command processes corresponding to each flag.

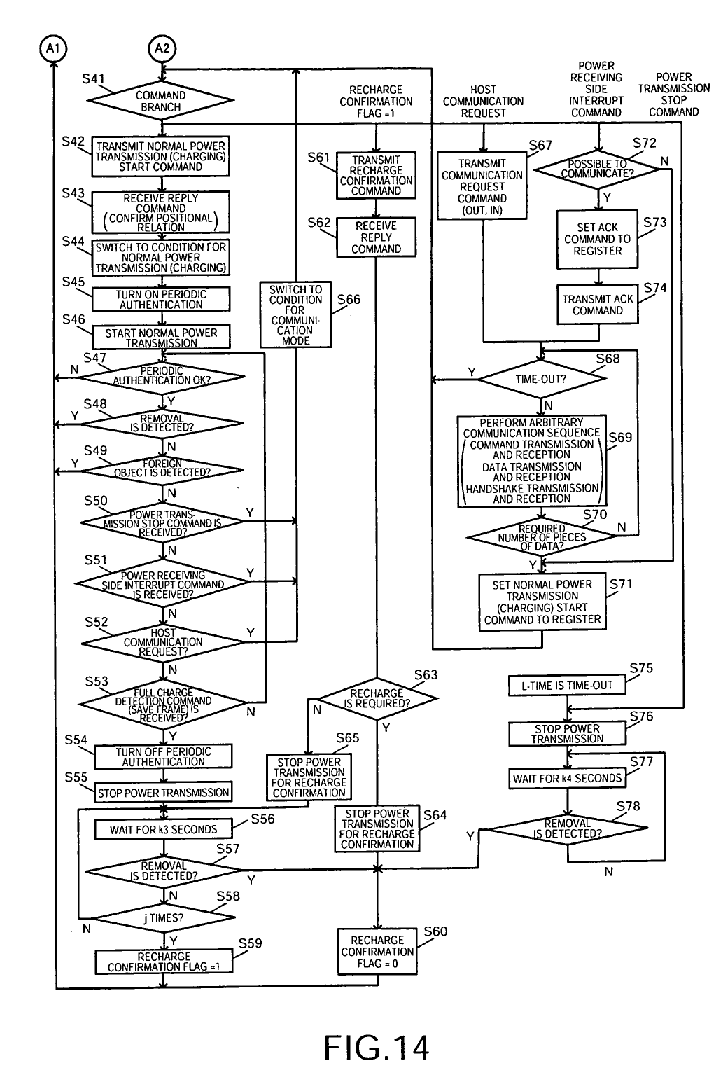

FIG. 14 is a flowchart showing processes on the power transmission side after the command branch. As shown in FIG. 14, at the command branch of step S41, if there is no command requiring a prior process (e.g., communication request, interrupt, power transmission stop, recharge confirmation flag=1, and the like), the power transmission side transmits the normal power transmission (charging) start command to the power receiving side (step S42). When receiving a reply command of the normal power transmission start command from the power receiving side, based on the position level information additionally included in the received reply command, the power transmission side confirms a positional relation between the primary coil L1 and the secondary coil L2 (step S43). Then, the transmission and communication conditions are switched to ones for the normal power transmission (step S44). Specifically, the conditions are switched to the transmission and communication conditions set in the setup process. Then, periodic authentication is turned on (step S45), and normal power transmission is started (step S46).

After the start of normal power transmission, in the periodic authentication period performed by the periodic load modulation, the power transmission side performs takeover state detection, which the takeover state is caused by a metal foreign object and the like having a large area (step S47). Subsequently, removal detection and foreign object detection are performed (steps S48, S49). If any takeover is detected in the periodic authentication, or a removal or a foreign object is detected, the power transmission is stopped, and the power transmission side returns to the step S1.

Next, the power transmission side determines whether or not a power transmission stop command (a STOP command) from the host 4 on the power receiving side is received (step S 50). Then, it is determined whether or not an interrupt command (an INT command) from the host 4 on the power receiving side is received (step S 51). Further, it is determined whether or not a host communication request (OUT/IN transfer commands) is received from the host 2 on the power transmission side (step S 52).

If there is no receipt of the commands or request, the power transmission side determines whether or not the full charge detection command (a save frame) is received from the power receiving side (step S53). If the command is not received, the power transmission side returns to the step S47. On the other hand, if the command is received, the periodic authentication is turned off, and the power transmission is stopped (steps S54, S55). Then, the power transmission side proceeds to the waiting phase after the detection of the full charge (step S56).

In the waiting phase after the detection of the full charge, for example, a removal is detected once every k3 seconds (step S57). Then, if a removal is detected, the recharge confirmation flag is reset to “0” (step S60). Thereafter, the power transmission is stopped, and the power transmission side returns to the step S1.

In the waiting phase after the detection of the full charge, for example, a recharge is confirmed once every k3×j seconds, and the recharge confirmation flag is set to “1” (steps S58, S59). Then, the power transmission is stopped, and the power transmission side returns to the step S1.

If the recharge confirmation flag is set to “1” in the step S59, the power transmission side returns to the step S1, and thereafter the negotiation process and the setup process are performed. At the command branch of the step S41, since the recharge confirmation flag is “1”, the process flow proceeds to a process on a recharge confirmation mode.

Specifically, the power transmission side transmits the recharge confirmation command to the power receiving side (step S61). When receiving a reply command of the recharge confirmation command from the power receiving side (step S62), based on a check result of a battery voltage received together with the reply command, the power transmission side determines whether or not the battery 94 needs to be recharged (step S63). If it is determined that the recharge is required, the power transmission for confirming a recharge (temporary power transmission) is stopped (step S64). Then, the recharge confirmation flag is set to “0”, and the process flow returns to the step S1. On the other hand, if it is determined that no recharge is required, the power transmission for confirming a recharge is stopped (step S65). Then, the power transmission side returns to the waiting phase after the detection of the full charge from the recharge confirmation mode (steps S56 to S58).

If it is determined that the power transmission stop command or the interrupt command is received in the steps S50, S51 and that there is a communication request from the host 2 in the step S52, the power transmission side switches the transmission and communication conditions of contactless power transmission to ones for the communication mode (a condition during the temporary power transmission) from ones for the normal power transmission (step S66). For example, the driving frequency and the driving voltage are switched, or a threshold parameter for detecting a load state of the power receiving side is switched. Then, the process flow proceeds to the command branch of the step S41.

For example, if it is determined that there is a communication request from the host 2 on the power transmission side in the step S52, at the command branch of the step S41, the process flow is branched to the process on the communication mode due to the host request. In the communication mode due to the host request, the OUT transfer command or the IN transfer command, which is the communication request command issued by the host 2, is transmitted to the power receiving side (step S67). Then, the power transmission side receives a reply from the power receiving side. Thereafter, it is determined whether or not a time-out occurs (step S68). If the time-out occurs, the process flow returns to the step S41. On the other hand, if no time-out occurs, an arbitrary communication sequence is performed based on an agreement between the hosts 2 and 4 (step S69). Then, it is determined that whether or not the required number of pieces of data is obtained (step S70). If the required number of pieces of data is obtained, the normal power transmission start command (a charging start command) is set to the command register 114 (step S71), and the process flow returns to the step S41. This enables the power transmission side to be returned to the normal power transmission mode (a charging mode) from the communication mode.

If it is determined that the interrupt command (the INT command) is received from the power receiving side in the step S51, at the command branch of the step S41, the process flow is branched to a process on the communication mode due to the interrupt command from the power receiving side. In the communication mode due to the interrupt command from the power receiving side, first, it is determined whether or not communication can be performed in a current state (step S72). If the communication cannot be performed, the process flow proceeds to the step S71. On the other hand, if the communication can be performed, the power transmission side sets the ACK command to the command register 114 so as to transmit it to the power receiving side (steps S73, S74). Then the process flow proceeds to the communication mode process of the steps S68 to S70.

If it is determined that the power transmission stop command (the STOP command) is received from the power receiving side in the step S50, at the command branch of the step S41, the process flow is branched to the process on the power transmission stop command. Then, the power transmission to the power receiving side is stopped (step S76), and removal detection is performed every k3 seconds (steps S77, S78), for example. If a removal is detected, the process flow proceeds to the step S60 and returns to the step S1. Further, if there is a time-out in an L-time timer for clocking continuous charging time (step S75), the process flow proceeds to the step S76 and the power transmission is stopped.

As described above, in the embodiment, the power transmission side switches conditions to ones for the communication mode when the event proceeding to the communication mode occurs, and then proceeds to the command branch (steps S51, S52, S66, S41). The power transmission side performs the command process for the communication mode, and after the completion of the communication mode, returns to the command branch (steps S67 to S71). Meanwhile, if a removal, a foreign object, or a full charge is detected, the power transmission side stops the power transmission (steps S48, S49, S53). The, after performing the temporary power transmission, the power transmission side performs the negotiation process, the setup process, and so on (steps S1 to S10), and then proceeds to the command branch. If the full charge is detected, the power transmission side proceeds to the waiting phase after the detection of the full charge (steps S56 to S58). In the waiting phase after the detection of the full charge, the power transmission side periodically performs the recharge confirmation process (steps S59 to S65).

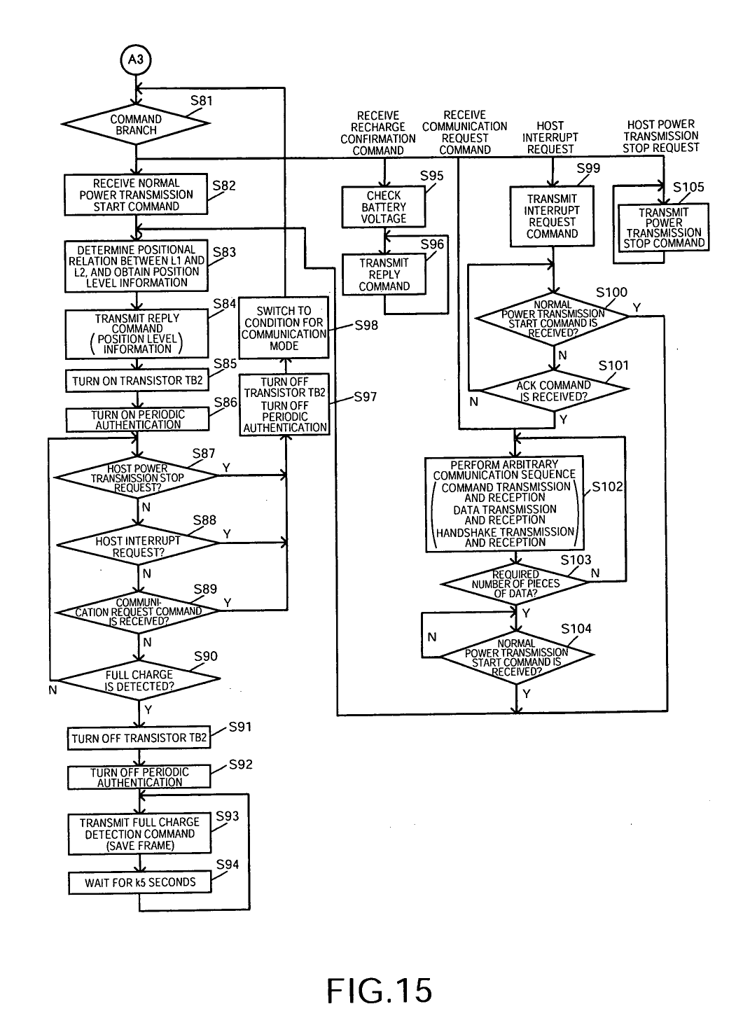

FIG. 15 is a flowchart showing processes on the power receiving side after the command branch. As shown in FIG. 15, at the command branch of step S81, if there is no command requiring a prior process (communication request, interrupt, power transmission stop, and the like), and the power receiving side receives the normal power transmission start command from the power transmission side (step S82), the power receiving side determines a positional relation between the primary coil L1 and the secondary coil L2 again so as to obtain position level information or positional relation information (step S83). Then, the power receiving side transmits a reply command additionally including the position level information to the power transmission side (step S84).

After transmitting the reply command, the power receiving side turns on the transistor TB2 of the power feeding control section 48 (step S85) so as to start power supply to the load 90. The power receiving side turns on the periodic authentication so as to perform a periodic load modulation (step S86). Specifically, the transistor TB3 of the load modulation section 46 is turned on/off in accordance with a predetermined pattern in the periodic authentication period.

Next, the power receiving side determines whether or not the power transmission stop request (the STOP command) from the host 4 on the power receiving side is received (step S 87). Then, the power receiving side determines whether or not the interrupt request (the INT command) from the host 4 on the power receiving side is received (step S 88). Further, the power receiving side determines whether or not the communication request command (OUT/IN transfer commands) is received from the host 2 on the power transmission side (step S 89).

If there is no receipt of the commands or a request, the power receiving side detects whether or not the battery 94 is fully charged (step S90). If the full charge is not detected, the process flow returns to the step S87. On the other hand, if the full charge is detected, the transistor TB2 is turned off (step S91), and the power supply to the load 90 is stopped. Further, the periodic authentication is turned off (step S92). Then, the full charge detection command (a save frame) that notifies the detection of the full charge is transmitted to the power transmission side (step S93). After a wait period of k5 seconds (step S94), the process flow returns to the step S93 so as to repeat the process.

If the power transmission side starts the power transmission for confirming a recharge (temporary power transmission), the power receiving side is powered on and reset. Then, the power receiving side performs the negotiation process and the setup process. When receiving the recharge confirmation command transmitted from the power transmission side (refer to the step S61), at the command branch of the step S81, the process flow proceeds to the process on the recharge confirmation mode.

Specifically, the power receiving side checks a battery voltage (step S95), and transmits a reply command with respect to the recharge confirmation command and a check result of the battery voltage to the power transmission side (step S96). Then, the power transmission for confirming a recharge is stopped, the power receiving side is powered off.

If it is determined that there is a power transmission stop request and an interrupt request from the host 4 in the steps S87 and S88, or that the communication request command is received in the step S89, the power receiving side turns off the transistor TB2 for power feeding as well as the periodic authentication (step S97). Then, the transmission and the communication conditions are switched to ones for the communication mode (step S98), and the process flow proceeds to the command branch of the step S81.

For example, if it is determined that the communication request command (OUT/IN transfer commands) is received from the power transmission side in the step S89, at the command branch of the step S81, the process flow is branched to the process on the communication mode due to the communication request from the power transmission side. Then, an arbitrary communication sequence is performed based on an agreement between the hosts 2 and 4 (step S102). Then, it is determined that whether or not the required number of pieces of data is obtained (step S103). If the required number of pieces of data is obtained, the power receiving side determines whether or not the normal power transmission start command transmitted from the power transmission side (refer to the step S71) is received (step S104). If the command is received, the process flow proceeds to the step S83, and the power receiving side returns to the normal power transmission mode (a charging mode) from the communication mode.

If it is determined that there is an interrupt request from the host 4 on the power receiving side in the step S88, at the command branch of the step S81, the process flow is branched to the process on the communication mode due to the interrupt request from the power receiving side. In the communication mode due to the interrupt request from the power receiving side, the communication request command (the INT command) is transmitted to the power transmission side (step S99). Then, it is determined whether or not the normal power transmission start command from the power transmission side is received (step S100). If the command is not received, the power receiving side determines whether or not the AKC command (refer to the step S74) is received (step S101). If the command is received, the process flow proceeds to the process on the communication mode of the steps S102, S103.

If it is determined that there is the power transmission stop request from the host 4 on the power receiving side in the step S87, at the command branch of the step S81, the process flow is branched to the process due to the power transmission stop request. Then, the power transmission stop command is transmitted to the power transmission side (step S105). When the power transmission is stopped, the power receiving side is powered off.

As described above, in the embodiment, the power receiving side switches conditions to ones for the communication mode when the event proceeding to the communication mode occurs, and then proceeds to the command branch (steps S88, S89, S97, S98, S81). The power receiving side performs the command process for the communication mode, and after the completion of the communication mode, returns to the command branch (steps S99 to S104). When the power transmission side proceeds to the waiting phase after the detection of the full charge, and performs the periodic temporary power transmission, the power receiving side performs the recharge confirmation process during the temporary power transmission (steps S95, S96).

While the embodiment has been described in detail above, it will be understood by those skilled in the art that a number of modifications can be made to the embodiments without substantially departing from new matters and advantages of this invention. Therefore, it is to be noted that such modifications are all included in the scope of the invention. For example, terms referred to as different terms having broader meanings or having the same definitions of the terms in the specification and drawings can be replaced with the different terms in any part of the specification and drawings. Further, combinations of the embodiments and modifications can be included in the scope of the invention. Also, the structures and the operations of the power transmission control device, the power transmission device, the power receiving control device, and the power receiving device, the proceeding process to the communication mode, the command process on the communication mode, process after detection of the full charge, communication process, host interface process, and the like are not limited those described in the embodiments, and various modifications can be made thereto.

1. A power transmission control device included in a power transmission device of a contactless power transmission system, comprising:
a controller controlling the power transmission control device, the controller including:
an authentication process section; and
a command process section,
the authentication process section performing an authentication process on a power receiving device before normal power transmission from the power transmission device to the power receiving device starts,
after the normal power transmission starts, if an event proceeding to a communication mode in which the power transmission device and the power receiving device communicate with occurs, the command process section proceeding to a command branch phase without proceeding to a phase of the authentication process, and performing a command process on the communication mode in the command branch phase.

2. The power transmission control device according to claim 1, the controller including a power transmission control section that stops the normal power transmission if a removal of an electronic apparatus on a power receiving side is detected, if a foreign object is detected, or if a full charge of a battery included in a load of the power receiving device is detected, the authentication process section performing the authentication process in a temporary power transmission period after the normal power transmission stops, and proceeding to the command branch phase after the authentication process phase in the temporary power transmission period.

3. The power transmission control device according to claim 1, further comprising a host interface to communicate with a power transmission side host, the command process section proceeding to the command branch phase so as to perform the command process on the communication mode if the power transmission side host issues a communication request command to a power receiving side host through the host interface.

4. The power transmission control device according to claim 3, the command process section proceeding to the command branch phase so as to perform the command process on the communication mode if the command process section receives a communication interrupt command issued by the power receiving side host.

5. The power transmission control device according to claim 3, the command process section returning to the command branch phase after the command process on the communication mode ends.

6. The power transmission control device according to claim 1, the command process section setting at least one of a transmission condition and a communication condition of the contactless power transmission to a condition for the communication mode, the condition being different from a condition for the normal power transmission, if the command process section proceeds to the communication mode.

7. The power transmission control device according to claim 1, if a full charge of a battery included in the load is detected and the normal power transmission stops, the controller proceeding to a waiting phase after the detection of the full charge, and including a recharge confirmation process section that periodically performs a recharge confirmation process on the battery in the waiting phase after the detection of the full charge.

8. The power transmission control device according to claim 7, the authentication process section performing the authentication process in a period in which a temporary power transmission is periodically performed in the waiting phase after the detection of the full charge, and proceeding to the command branch phase after the authentication process in the temporary power transmission period.

9. The power transmission control device according to claim 8, the recharge confirmation process section setting a recharge confirmation flag to a set state at a time at which the waiting phase after the detection of the full charge proceeds to the authentication process phase.

10. The power transmission control device according to claim 9, the recharge confirmation process section setting the recharge confirmation flag to a reset state if it is determined that the battery needs to be recharged in the recharge confirmation process and the normal power transmission starts.

11. The power transmission control device according to claim 7, the recharge confirmation process section transmitting a recharge confirmation command to the power receiving device in the recharge confirmation process, and determining whether or not the battery needs to be recharged, when receiving a reply command notifying a charging state of the battery from the power receiving device, based on the reply command.

12. A power transmission device, comprising: the power transmission control device according to claim 1; and a power transmission section generating an alternating voltage so as to supply the voltage to a primary coil.

13. An electronic apparatus, comprising: the power transmission device according to claim 12.

14. A power receiving control device included in a power receiving device of a contactless power transmission system, comprising:
a controller controlling the power receiving control device, the controller including:
an authentication process section; and
a command process section,
the authentication process section performing an authentication process on a power transmission device before normal power transmission from the power transmission device to the power receiving device starts,
after the normal power transmission starts, if an event proceeding to a communication mode in which the power transmission device and the power receiving device communicate with occurs, the command process section proceeding to a command branch phase without proceeding to a phase of the authentication process, and performing a command process on the communication mode in the command branch phase.

15. The power receiving control device according to claim 14, further comprising a host interface to communicate with a power receiving side host, the command process section proceeding to the command branch phase so as to perform the command process on the communication mode if the power receiving side host issues a communication request command to a power transmission side host through the host interface.

16. The power receiving control device according to claim 15, the command process section proceeding to the command branch phase so as to perform the command process on the communication mode if the command process section receives an interrupt command to request communication, the command being issued by the power transmission side host.

17. The power receiving control device according to claim 14, the controller including a recharge confirmation process section, if a full charge of a battery included in a load of the power receiving device is detected and the normal power transmission stops, the power transmission device proceeding to a waiting phase after the detection of the full charge, the recharge confirmation process section transmitting a replay command notifying a charging state of the battery to the power transmission device if the recharge confirmation process section receives a recharge confirmation command from the power transmission device in the waiting phase after the detection of the full charge.

18. The power receiving control device according to claim 17, if the power transmission device periodically performs a temporary power transmission for a recharge confirmation in the waiting phase after the detection of the full charge, the recharge confirmation process section receiving the recharge confirmation command and transmitting the reply command in a period of the temporary power transmission for the recharge confirmation.

19. A power receiving device, comprising: the power receiving control device according to claim 14; and a power receiving section converting an induced voltage in a secondary coil into a direct current voltage.

20. An electronic apparatus, comprising: the power receiving device according to claim 19; and a load to which power is supplied by the power receiving device.

21. A contactless power transmission method in which power is transmitted from a power transmission device to a power receiving device by electromagnetically coupling an elementary coil and a secondary coil and the power is supplied to a load of the power receiving device, the contactless power transmission method comprising:
performing an authentication process on the power receiving device before normal power transmission from the power transmission device to the power receiving device starts;
proceeding to a command branch phase without proceeding to a phase of the authentication process if an event proceeding to a communication mode in which the power transmission device and the power receiving device communicate with occurs, after the normal power transmission starts; and
performing a command process on the communication mode in the command branch phase.

22. The contactless power transmission method according to claim 21, the normal power transmission being stopped if a removal of an electronic apparatus on a power receiving side is detected, if a foreign object is detected, or if a full charge of a battery included in a load of the power receiving device is detected; a temporary power transmission being performed after the normal power transmission stops; the authentication process being performed in a period of the temporary power transmission; and the command branch phase being after the authentication process phase in the temporary power transmission period.

23. The contactless power transmission method according to claim 21, at least one of a transmission condition and a communication condition of the contactless power transmission being set to a condition for the communication mode, the condition being different from a condition for the normal power transmission, if proceeding to the communication mode.

24. The contactless power transmission method according to claim 21, proceeding to a waiting phase after detection of a full charge, if the full charge of a battery included in the load is detected and the normal power transmission stops; and a recharge confirmation process on the battery being periodically performed in a waiting phase after the detection of the full charge.

25. The contactless power transmission method according to claim 21, it being determined whether or not the battery needs to be recharged, if a charging state of the battery is received from the power receiving device in the recharge confirmation process on the battery, based on the charging state.
